(19) United States
(12) Patent Application Publication
(10) Pub. No.: US 2006/0020530 A1
(43) Pub. Date: Jan. 26, 2006

(54) Systems for providing financial services

(76) Inventors: Phillip Koh-Kwe Hsu, Ho Ho Kus, NJ (US); Brian Joseph Martone, Hoboken, NJ (US); Richard F. Murphy, Somers, NY (US); Michael Francis Murphy, River Edge, NJ (US)

Correspondence Address: PROSKAUER ROSE LLP, ONE INTERNATIONAL PLACE 14TH FL, BOSTON, MA, 02110, US

(21) Appl. No.: 11/152,564

(22) Filed: Jun. 14, 2005

Related U.S. Application Data
(63) Continuation of application No. 09/685,924, filed on Oct. 10, 2000.
(63) Continuation of application No. 10/143,477, filed on May 10, 2002.
(63) Continuation of application No. 09/712,358, filed on Nov. 14, 2000.
(60) Provisional application No. 60/182,364, filed on Feb. 14, 2000.

(51) Int. Cl. G06Q 40/00

(52) U.S. Cl. 705/35

(57) ABSTRACT

The present invention provides an intranet system for a financial service corporation. The present invention also provides a browser interface for financial services. The interface comprise a toolbar; a task menu wherein each task is associated with a number of financial applications; an object menu associated with each task which provides a link to each financial application; and an action menu for presenting one or more actions specific to a user-selected financial application. The task menu is always present on the browser interface and the object and action menus vary depending upon the options selected. The financial applications include market monitoring functions, portfolio reviews, model balancing, and automated trading.

### CROSS REFERENCE TO RELATED APPLICATIONS

This application claims priority to and the benefit of U.S. patent application Ser. No. 10/143,477, filed on May 10, 2002, which claims priority to and the benefit of U.S. patent application Ser. No. 09/712,358, filed on Nov. 14, 2000, which further claims priority to and the benefit of U.S. Provisional Patent Application Ser. No. 60/182,364, filed on Feb. 14, 2000, each of which are incorporated by reference herein. This application also claims priority to and the benefit of U.S. patent application Ser. No. 09/685,924, filed on Oct. 10, 2000, which is incorporated by reference herein.

### TECHNICAL FIELD OF THE INVENTION

The present invention relates to financial consulting; and more particularly, to a browser interface and client-server system for providing financial services. The present invention also relates to an intranet system for a financial service corporation.

### BACKGROUND OF THE INVENTION

Many people turn to financial advisors for specialized investment advice. Typically, financial advisors utilize a number of disparate tools to formulate a discrete financial plan. These include financial planning calculators, review of historical market trends and yield calculations, and the like. In some instances, certain of these tools may be automated; others require manual use.

The financial industry has identified the need to automate financial services. For example, U.S. Pat. No. 5,132,899 discloses a computer data gathering and processing methodology that facilitates access to various data including investment performance, Securities Exchange Commission reports, and stock financial characteristics to produce a list of stocks for purchase for investment and operating accounts. U.S. Pat. Nos. 5,710,889 and 5,890,140 disclose a device and system for electronically integrating a plurality of financial services from different geographical locations and in different time zones.

There have likewise been developed a number of computerized financial advisory systems. U.S. Pat. No. 5,918,217 discloses a user interface which allows a user to interactively explore how changes in one or more input decisions, such as risk tolerance, savings level, and retirement age affect one or more output values such as the probability of achieving specified financial goals. Some of these tools are available over the Internet. At <<http://www.armchairmillionaire.com/fivesteps/intro.html>> there is provided an interactive savings tool, which explores how to build a million-dollar portfolio, based on total dollar inputs.

In some instances, there have been attempts to integrate different automated financial tools. U.S. Pat. No. 5,245,535 discloses a system for demonstrating and displaying different financial concepts, which includes a central processing unit for processing financial information from numerical data and a display means for displaying the financial information in graphic and textual form. U.S. Pat. No. 5,214,579 discloses a data processing system that manages, monitors and reports the growth of a participant's investment base with respect to progress in achieving a predetermined target amount.

None of the patents or systems described above discloses a secure system, having a myriad of integrated financial application and tools which can be easily navigated by financial advisors. Furthermore, with the proliferation of investors in recent times and the ever-increasing use of the Internet to disseminate financial information as well as a medium for investors to open up and manage accounts, financial advisors may have a difficult time marshalling all of the necessary data required to effectively manage and/or advise their clients.

An intranet is a private network that is contained within an enterprise. One purpose of an intranet is to share company information and computing resources among employees. Oftentimes, however, a company does not need to provide all available content to all users. In many instances, it is necessary to limit users to particular information, applications, functions and web pages. For instance, in the setting of a financial service corporation, it is costly to provide market data information that is accessed, at a cost, from an external service, e.g., Quotron by Reuters. Accordingly, there is a need in the art for an intranet system that can limit information, etc. that a user can access.

The presently available intranet systems available are also unmanageable as no mechanism exists for easy editing and updating of content. It, therefore, would also be advantageous for the content of an intranet system to be easily managed.

### SUMMARY OF THE INVENTION

According to one aspect of the invention, a browser interface is provided for an integrated financial services system. The interface includes a browser toolbar and a task menu providing a number of user-selectable tasks that correspond to various activities performed by financial advisers on a daily basis. Each task is associated with a group of financial applications logically associated with the task. An object menu is associated with each user-selected task so as to provide the user with a user-selectable link for initiating each financial application associated with the user-selected task. Once initiated, each financial application includes an action menu for presenting one or more actions specific to the user-selected financial application. The interface also includes at least one view window for presenting information from at least one of the financial applications.

In the preferred embodiment, each task selection is associated with an object menu that is viewable when the task is selected by the user. The task menu preferably presents one or more of the following task selections: a default task; client information; investor consulting services; products and investments; tools; and management. The default task is associated with one more of the following object menu selections: research; applications; market data; client inquiry; Infonet (an information resource web site); and dynamic market data. The investor consulting services task is associated with one more of the following object menu selections: online portfolio review; financial planning; and trading.

According to another aspect of the invention, a method of preparing and tracking client presentations is provided. According to this method a presentation file having a plurality of slides is uploaded to a database. The presentation file is then split into individual slides, which are separately stored in the database. A user interface is provided for enabling a user to select any of the individual slides for a new client presentation. The identity of the client for the new client presentation is stored in the database as well as data indicating the individual slides which compose the new client presentation. In this manner, presentations can be created from a central, management-approved, repository, and management can track what information has been presented to clients or prospective clients.

According to yet another aspect of the invention, a method of balancing a financial portfolio comprising multiple accounts is provided. The method includes: selecting multiple financial accounts from a database of client financial accounts; selecting a financial model; comparing the holdings in the selected multiple financial accounts, in aggregate, against the financial model; and initiating buy and sell orders, as required, in order to substantially equalize the selected multiple financial accounts, in aggregate, with the financial model. The selected accounts are preferably balanced with the financial model to within a rounding factor. In this manner, financial advisors can more effectively manage householded accounts.

According to still another aspect of the invention, a method of analyzing a financial portfolio is provided. The method includes: selecting a plurality of financial accounts from a database of financial accounts; selecting a comparative index evaluator against which to evaluate the selected plurality of accounts; and visually comparing the asset allocation of the selected plurality of accounts against the asset allocation of the comparative index evaluator. The method enables financial advisors to more effectively manage householded accounts.

The invention also provides an intranet system for a financial services entity, comprising an interface application for accessing at least one internal data source and at least one external data source that a user is entitled to access; and an authentication system for determining which data sources a user is entitled to access, displaying the data sources on the interface application and setting a user preference profile. Advantageously, the system of the present invention provides timely information to a user. Furthermore, the system may also allow content providers and administrators access through the same authentication processes as any other user.

The invention also provides a system for providing financial information to end users in a network environment comprising an interface having means for selectively displaying information from an internal data source and an external data source; and means for controlling the display of the information; and an authentication system having means for determining a set of data sources that a user is entitled to selectively access and display; and means for setting user preferences for the user based on a stored user preference profile.

### BRIEF DESCRIPTION OF THE DRAWINGS

The invention will be more fully understood and further advantages will become apparent when reference is made to the following detailed to description of the preferred embodiments of the invention and the accompanying drawings, in which:

FIG. 1 is a block diagram of a network based financial service system;

FIG. 2 is a schematic representation of a computer/workstation for 15 accessing the system of FIG. 1 via the Internet;

FIG. 3 is a block diagram of the software hierarchy of a host server of the system;

FIG. 4 is a block diagram of an authentication system;

FIGS. 5-7 are flow diagrams of operation of the authentication system;

FIGS. 8A-B are video screen displays illustrating authentication login screens, respectively;

FIG. 9 is a screen display illustrating a browser interface, and in particular, an order entry application;

FIG. 10 is a screen display of a market data function;

FIG. 11 is a screen display of a financial research information web site;

FIG. 12 is a screen display of a client inquiry application;

FIG. 13 is a screen display of an intranet web site;

FIG. 14 is a screen display of a dynamic market data function;

FIGS. 15-23 are screen displays of various tools associated with an online portfolio review application;

FIG. 24 is a screen display of an Insightone™ application;

FIG. 25 is a screen display of a financial planning application;

FIGS. 26-35 are screen displays of various tools associated with an investment consulting services trading application;

FIG. 36 is a screen display of a client reporting function;

FIG. 37 is a screen display of a branch report function;

FIG. 38 is a screen display of a portfolio management report function.

FIG. 39 is a block diagram of an intranet system in accordance with the present invention;

FIG. 40 is a video screen display illustrating the intranet system login dialog;

FIG. 41 is a video screen display illustrating an interface application for a particular user;

FIG. 42 is a block diagram of a content management system;

FIG. 43 is a block diagram of an authentication system; and

FIGS. 44-46 are systems flow diagrams depicting operation of the authentication system.

### DETAILED DESCRIPTION OF THE INVENTION

One embodiment of the present invention is described as follows:
I. System and Components
   A. Software Overview
   B. Browser Interface Overview
   C. Authentication System Overview
   D. Computer or Workstation
   E. Host Server(s)
II. Software
III. Authentication System
IV. Browser Interface & Functional Description
   A. Main Menu (Home)
      1. Applications
      2. Market Data
      3. Research
      4. Client inquiry
      5. InfoNet
      6. Dynamic Market Data
   B. Investment Consulting Services (ICS)
      1. Online Portfolio Review
      2. Insightone Website
      3. ICS Financial Planning
      4. ICS Trading
   C. Client Info
      1. View
      2. Branch Reports
      3. Portfolio Management Reports
         I. System and Components:

The present invention provides specially integrated tools for processing and viewing market data and research, providing financial planning, conducting financial transactions and monitoring investor activities. The advanced technology platform afforded by the present invention provides a browser interface, accessible over the Internet, to offer timely, proactive financial advice based on real-time financial data and a myriad of finance related applications.

A. Software Overview:

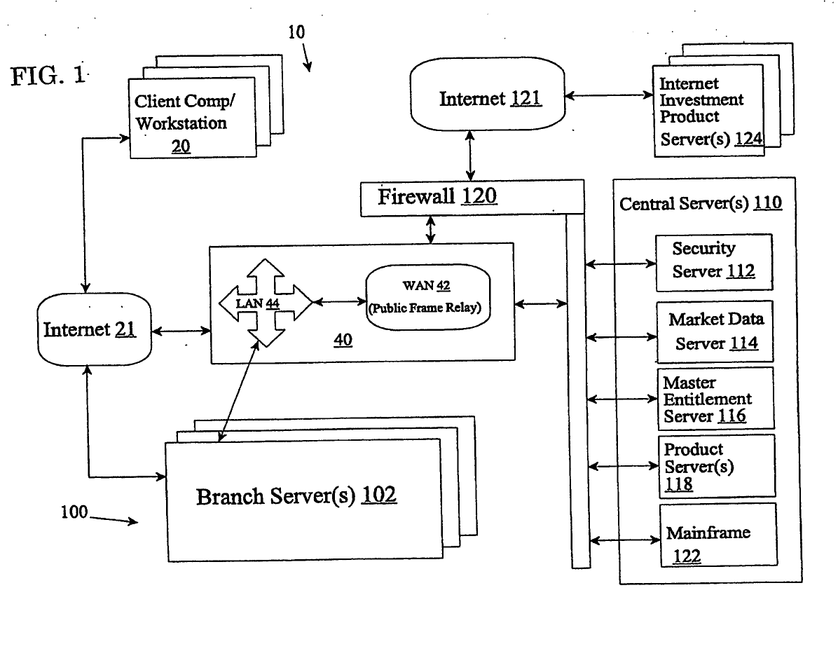

Referring to FIG. 1, there is shown a financial service system 10 which incorporates a number of different software applications, functions and information content Web sites/pages, which, for purposes of this disclosure, are generically referred to as “objects” or “system features” (“features” for short). For further purposes of this disclosure, an “application” is software that provides a variety of functions and calculations, and a “function” is a discrete, more granular procedure such as selecting and reporting data.

In a preferred embodiment, system 10 includes a set of objects that can be used to process and view real-time market data and assist financial planning. Additional, preferred objects may be used to perform market research and monitor and assist in investor-mediated financial activities. The stability, functionality, easy usability and flexibility of the integrated system of the invention provide timely, proactive advice and counsel, thereby furthering investor goals.

The objects may reside in part on any component server or database of host server 100, shown in FIG. 1, for access by a client computer or workstation 20 via the Internet.

B. Browser Interface Overview:

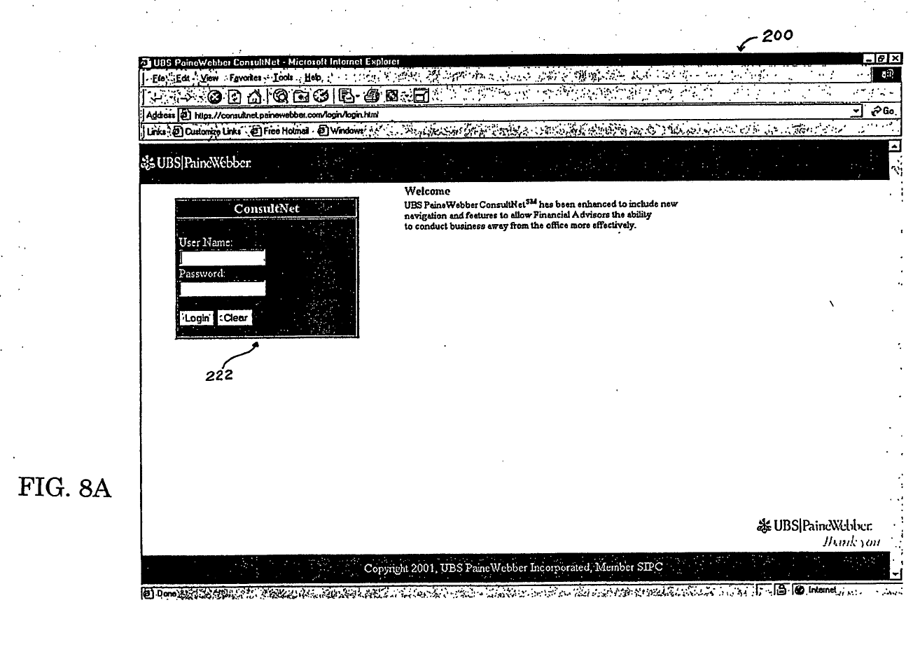

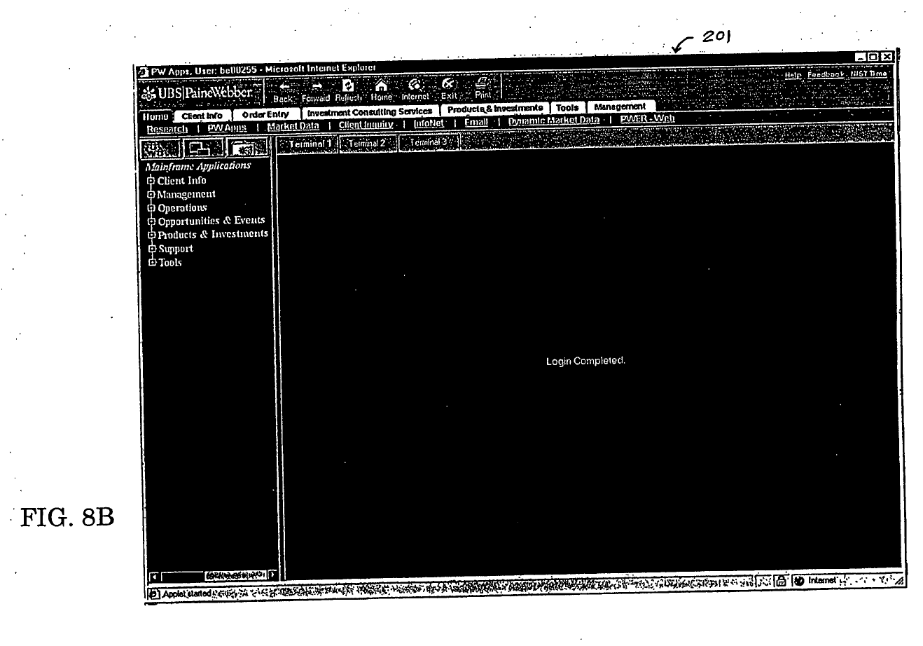

In a preferred embodiment, objects are integrated with a browser interface 200 (or controlled shell), shown in FIGS. 8A-38, in a manner that enables a user to view one or more graphical displays from a given object.

Accordingly, system 10 provides a multitasking environment in which more than one objective application, function or Web site and/or page can be simultaneously run and/or viewed by the user. In this environment, an interface may have two or more windows, each representing a different object governed by its own protocols distinct to that object. The user can move between different windows, without having to constantly enter and exit each object of interest. Depending on the particular needs or questions of the user, appropriate objects can be accessed and utilized to generate financial information. For example, the user could request research on particular market sectors and specific equity positions within that sector. In a preferred embodiment, browser interface 200 is accessible from a workstation 20 via the Internet to access a plurality of financial applications and a plurality of market data functions. Real-time market data can be utilized in conjunction with financial applications in order to provide comprehensive financial assistance. In another instance, the user (i.e., financial adviser) may desire to monitor the activities of his or her client through an investor monitoring system. Here, the user could intercede in an order entered by the client or, alternatively, contact the client to discuss the ramifications of a particular order. Preferably, a scratchpad interface for moving information between the objects may also be provided.

C. Authentication System Overview:

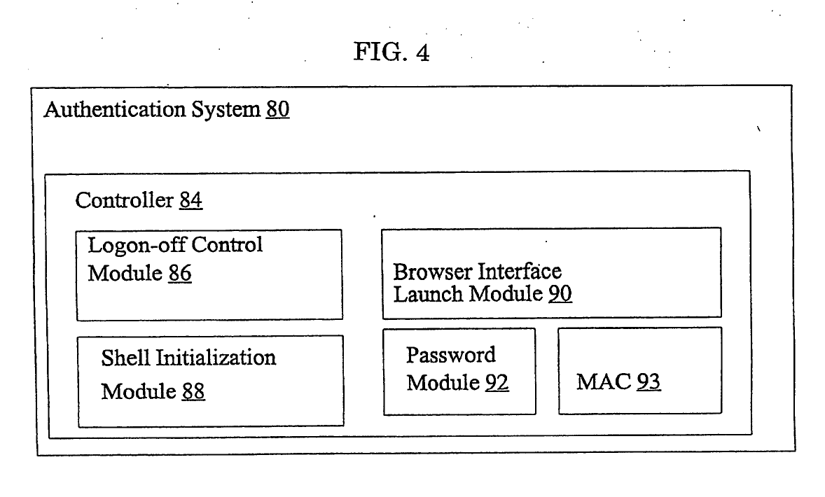

The invention also may include an authentication system 80, shown in FIG. 4, described in detail further below. Generally stated, once communications to a host server have been established, a user logs onto system 10 and accesses authentication system 80, where the user enters a password and preferably, other authentication information such as a universal user name. This information is transmitted to a security system resident in host server 100 where a user is authenticated. This provides for confirmation of a user's identity. Concomitantly, user access is denied where authentication fails. The security functionality described herein also represents a single point of security control for adding or removing a user from the system 10. Preferably, the security system is resident in more than one component of host server 100 in order to provide load balancing and disaster recovery.

In addition, authentication system 80 also provides access to a user entitlement level containing a list of objects according to user entitlement. That is to say, different users are accorded different entitlement levels and as such, access to specific objects resident in system 10. For example, a sales person would not receive alerts regarding investor-mediated transactions and therefore would not be allowed access to those applications. Most preferably, a separate user entitlement level associates a user with specific market data.

In a preferred embodiment, the authentication system also contains a move/add/change (MAC) function 93 that updates the security 25 function with new or changed user information. Preferably, the MAC function 93 updates the security function with new or revised user names, social security functions, unique advisor identification number (where appropriate), identification for market data entitlements, and satellite branch identifiers (where appropriate), as well as an e-mail alias and title. The MAC function 93 is a single entry point to fully add or remove a user from all required security or distributed systems that support platform functionality.

In addition, authentication system 80 accesses a user customized preference profile resident on the host server 100. The user preference profile allows a user to customize his or her browser interface and object settings, such as market data function preferences.

By providing the entitlement levels and preference profiles, the present invention allows a user to access system 10 entitlements via the Internet. In addition, the user retains all of his or her preferences set during a user's previous usage.

D. Computer or Workstation:

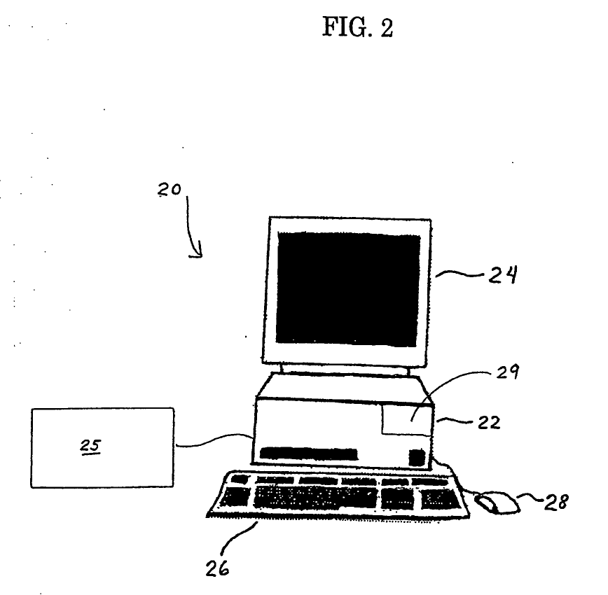

A component of the present invention is a client computer or workstation 20 including Internet 21 access. (This differs from Internet access relative to firewall 120 only.) Workstation 20 can be used to review real-time market conditions, obtain research, assist financial planning, monitor financial activities, enter orders for the execution of security transactions, and conduct numerous other financial activities. Workstation 20 is fast, simple to use, and is readily adaptable to the needs of the user. As shown in FIG. 2, workstation 20 includes a central processing unit 22, a video display screen (VDS) 24, communication system 29 for communicating between workstation 20 and at least one host server 100 via the Internet 21, and a browser interface 200 (shown in FIGS. 8A-38).

VDS 24 is connected to a color video graphic controller card of workstation 20 and provides means by which financial information is displayed on VDS 24 in graphic form. Preferably, CPU 22 is housed in a single stationary or portable unit. CPU 22 of a stationary workstation 20 may comprise an IBM desktop personal computer with 96 megabytes of RAM, a 350 megahertz INTEL Pentium II processor, a 4.5 gigabyte hard drive, and a color video graphic controller card. Preferably, VDS 24 is a 17-inch color monitor with a screen resolution of at least 800×600 pixels, such as those sold by Sony Corp. of America. As an option, a printer 25 may be connected to CPU 22.

A portable workstation may likewise be used with system 10. In one embodiment, the portable workstation comprises, for example, a laptop computer having at least a 166 megahertz INTEL Pentium processor, 64 kilobytes of RAM, and a screen resolution of at least 800×600 pixels.

As mentioned above, workstation 20 also includes Internet access. To this end, communication system 29 includes a modem having a speed of 28.8 kilobytes per second (Kbps), although a modem speed of 56 Kbps is preferred. Of course, high-speed connections such as ISDN, cable modems, or digital subscriber lines may be used. Preferably, all data transmitted over the Internet is encrypted, e.g., with 128-bit encryption or like technology. Encryption ensures that account integrity will be maintained. It should be recognized that while the present invention will be described in terms of “Internet” communication, that more specific communication networks, such as a virtual private network or secured extranet, are considered to be within this realm. In any case, connectivity is preferably provided by conventional TCP/IP sockets-based protocol.

CPU 22 also includes mechanisms for selectively controlling the display of information on VDS 24 as well as devices for entering data into the system. Preferably, workstation 20 includes a keyboard 26 and a mouse 28 for entering information and directing the graphical display on VDS 24.

All of the hardware elements described herein may be readily replaced with other existing or later-developed elements that perform similar functions. For example, many different types of CPU's may be used instead of the unit described above.

Likewise, touch screen displays, light pens, track balls, keypads, stylus-type input devices or any other input device may be used instead of or in addition to keyboard 26, mouse 28, or both.

Every workstation 20 is programmed with operating system software such as Windows NT® 4.0 from Microsoft Corp. Each workstation 20 may 25 also contain a number of software applications. For example, workstation 20 may have a suite of applications from Microsoft Office® (i.e., Outlook, Word, Excel, PowerPoint), Norton Utilities®, various proprietary software for authenticating user access to the workstation, and non-proprietary finance-related applications. Each workstation 20 is also equipped with an Internet browser such as Microsoft's Internet Explorer®4.0 or greater, or Netscape Navigator. Alternatively, as will be discussed below, these applications may be resident on the host server and accessed as necessary via browser interface 200. The hardware and software framework described herein allows a user at any workstation 20 to access a host server 100 via the Internet, and utilize all available objects resident therein to which the user is entitled. In this way, system 10 can be used to provide superior financial assistance from remote locations.

E. Host Server(s):

In a preferred embodiment, the objects necessary to practice the present invention may reside a single server computer. However, as is evident from FIG. 1, system 10 preferably includes more than one server 10 computer, which collectively are referred to as “host server” 100. Any number of workstations 20 may connect to host server 100 via the Internet 21. System 10 is preferably implemented in such a way as to optimize on infrastructure costs. Client workstations connect to the system from the Internet using Internet Explorer 4.x or greater. All server code utilizes Netscape Enterprise Server and Server Side JavaScript (LIVEWIRE). CISCO Distributed Director (which is utilized for Load-Balancing, Fail-Over and Disaster Recovery) controls access to product server(s) 118 from referencing the Universal Resource Locator (URL). As will be discussed in greater detail later, user authentication is accomplished via authentication processes run against the master entitlement server 116. User entitlements and permissions are achieved through access to the master entitlement server 116, using profile information gathered from the authentication process. For the purpose of this disclosure, master entitlement server 116 may comprise one or more servers; for example, an authentication server for user authentication and an entitlement server for establishment of user entitlements and permissions. Other preferable tools which are maintained in host server 100 are built in JAVA and are resident at browser interface 200. These include: 1) a navigation bar feature which provides for “closed browser shell” navigation to all entitled objects; 2) a scratchpad feature which provides for object to object “stickiness” or context (e.g., carries information such as a symbol or account number from application to application without re-entry) and also allows the ability for single sign-on for multiple applications/content; and 3) a customized application built around IBM's Host On Demand (HOD) 327x emulation which provides for the establishment of a user entitlement based NAVIGATION TREE. Market data information is built using JAVA-based web pages from data accessed on market data server 114 as well as any other market data servers not shown in FIG. 1, such as those maintained as part of branch server 102, using user profile information supplied from the navigation feature. System 10 utilizes identical central server 110 components to the system described in the co-pending application entitled “System for Providing Financial Services.”

II. Software

The only software necessary to practice the present invention on workstation 20 is an Internet browser such as Microsoft's Internet Explorer and any Internet access software required, e.g., Internet service provider dial up software. Workstation 20 accesses host server 100 via Internet 21 either by accessing branch server 102, which in turn may access other components 15 of host server 100, or via centralized communication system 40. Objects are provided over Internet 21 from host server 100 to workstation 20, as described below.

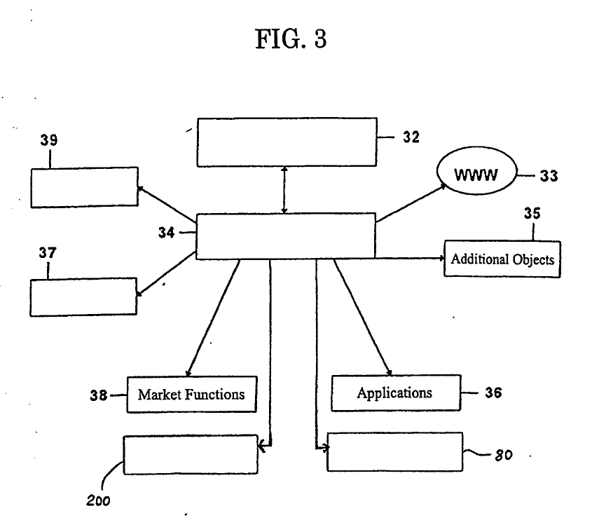

Referring to FIG. 3, a software hierarchy of host server 100 is shown. At the lowest level of the software hierarchy, operating system software 32 is provided. Preferably, operating system software 32 is a Windows NT® 4.0 operating system from Microsoft Corp. As well known by those having skill in the art, operating system software 32 causes the hardware components to operate in combination with one another by accepting input data, processing input data, and producing output data.

Conventional communications software 34 runs on top of operating system 32. This software permits user interaction with a keyboard, mouse or similar input device of host server 100 to control the operation of the software and other applications resident on the host server 100. It also serves as a means for transmitting information between the components of host server 100. As indicated in FIG. 3, communications software 34 is also linked to the Internet access 33, which accesses Internet 121 through firewall 120. Due to firewall 120, Internet access 33 of host server 100 allows a user to more securely conduct search via system 10 for investment information, background information, breaking news that affects investments and the like. Internet access 33 also allows a user to communicate with other users through system 10 and with clients via e-mail packages such as provided by Microsoft Outlook. This provides means to access the Internet, send e-mail, search at least one browser-based information system, etc.

Browser interface 200 and authentication system 80 are applications running on top of operating system software 32. The function and details of these applications are discussed below.

As shown in FIG. 3, communications software 34 is also preferably 10 linked to various objects that may be categorized, for convenience of description only, as a plurality of market monitoring objects 38, a plurality of functional application objects 36, and a plurality of additional objects 35. These objects will be discussed in more detail relative to browser interface 200 below.

In accordance with the present invention, the system 20 can incorporate an unrestricted number of different applications, functions and Web sites/pages. Furthermore, system 10 may include any other software 39 (FIG. 3) necessary for operation. It should be recognized that while objects are described as being “on” system 10, they be either physically located on a server or database of system 10 or may be accessed (e.g., via Internet 121 through a firewall 120) from third party service providers, e.g., Internet investment product server(s) 124.

III. Authentication System

Referring to FIGS. 4-7, an authentication system 80 of the invention is shown in greater detail. Authentication system 80 allows a user to access objects by user entitlement and access a user preference profile for that user regardless of where a workstation 20 is physically located.

Users are provided with an object suite based on a pre-determined user entitlement level. A user's entitlement level may be determined by their functional position, e.g., financial advisor, client service associate, operations manager, branch office manager, and division manager. Objects can be added or deleted to a user entitlement level as necessary. All security updates, new user, objects, adds, or changes may require secondary approval, before they are processed. It should be recognized that while the description discusses a single user entitlement level, more than one entitlement level may exist for a user, e.g., one for market data functions and another for applications.

Authentication system 80 uses the user's entitlement level to build browser interface 200 for a user. A user entitlement level is stored in an entitlement database(s) within system 10 and may include a number of identifications or passwords for the user, e.g., universal user name (UUNAME) including, for example, parent branch wire code (2 digit unique branch designation) and a Quotron® user identification (QUID). A customized user preference profile is also stored in a distributed/shared file space (DFS) which is preferably maintained within master entitlement server 116 of system 10 and contains customized settings of a user, e.g., user network registry settings for preferencing directories and files, taskbar settings, etc. A user's preference profile will be used to build browser interface 200 and provide the user with preferences that he or she has previously set.

Authentication system 80 also preferably includes a move/add/change (MAC) function 93 (FIG. 4), which provides a single point of control for all updates to user preference profiles, which in turn perform synchronous updates to all required security platforms, directories, entitlement and permission database, market data entitlements (e.g., QUID), all e-mail account information for simple mail transfer protocol (SMTP) or Microsoft Exchange based e-mail services, and all printer account information. MAC function 93 provides for distributed administration of client accounts. For example, each branch preferably has a designated MAC staff member who, via MAC function 93, has the permission to update user entitlements for those users that access system 10 from Internet through their respective branch server 102. This distributed updating is a significant advantage to the overall operation of the platform because a local administrator can administer local staff. If desired, changes may require secondary approval, for instance, by a branch manager, thereby maintaining tight security control of this distributed function.

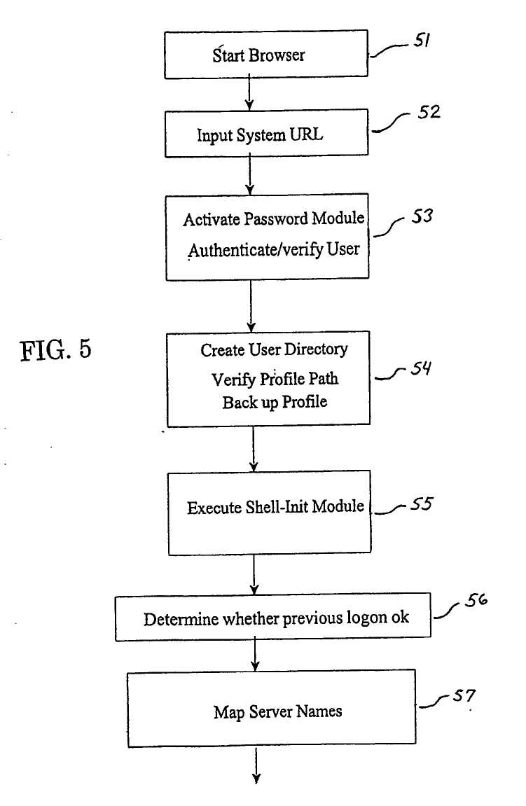

As shown in FIG. 4, authentication system 80 includes a controller 84, a logon-off control module 86, a shell initialization module 88, a browser interface launch module 90, a password module 92 and MAC function 93. Operation of authentication system 80 will be described relative to FIGS. 5-7. It is also noted that authentication system 80 will be described relative to a host server 100 having multiple components. While authentication system 80 is preferably used in a distributed server system, it should be recognized that the servers described might be condensed into a single server.

Referring to FIG. 5, in a first step S1, a user starts a workstation 20 and starts an Internet browser thereon, which accesses the Internet 21 in a known fashion. In step S2, a user inputs a uniform resource locator (URL) into the browser on their workstation 20 that will access an appropriate server of system 10. When the system 10 is accessed, controller 84 activates logon-off control module 86, which oversees the logging in process.

As will become evident, controller 84 (sometimes through modules 86, 88, 90, 92) governs a number of activities including retrieving a user's preference profile, populating browser interface 200, finding a user's entitlement level, retrieving numerous user identifications (e.g., parent branch wirecode, market data server ID, outside Internet investment product server ID and security ID for use by shell initialization module 88), creating a local user directory based on a user's preference profile, storing user password(s) in a library for objects to retrieve, setting an access control list on a logging in user's directory to provide full control, verifying and backing up user preference profiles, removing local preference profiles (excepting defaults, administrative and guest settings), and notifying a user of password expiration.

Next, at step S3, controller 84 authenticates a user logging on by activating password module 92. Password module 92 may access a special security server 112 (FIG. 1) of central server(s) 110 to authenticate a user. Upon initialization of security server 112, a user will be presented with a dialog for input of a user name and password (shown in FIG. 8A). Controller 84 may also indicate that a password change is required, i.e., it is about to expire based on information from security server 112. At this time, the MAC function 93 notifies the user that a password-reset operation has been performed and the password must be changed. The password may be changed in any conventional way of inputting a new password with a confirmation.

At step S4, controller 84 creates a local user directory, verifies that a user preference profile path exists and backs up the user preference profile. A user preference profile may exist on a branch server 102 or another server within system 10. A user preference profile includes a number of directories and files of the user, called a registry, that are used by system 10 to access a 10 user's information. If controller 84 cannot verify a path, authentication system 80 uses a default profile. If a registry fails to load for a user, controller 84 may attempt to use a user's last known profile, which may be accessible from a back up of the profile. Creating a local user directory on workstation 20 includes mapping the directories of workstation 20 to the registry of directories and files for a user.

At step S5, after a user is authenticated, logon-off control module 86 executes shell-initialization module 88 (hereinafter “shell-init module”).

At step S6, shell-init module 88 determines whether a previous logon did not proceed normally. If this is the case, shell-init module 88 undoes the changes made during last logon, i.e., it remembers user preference profile changes made during the previous logon.

At step S7, shell-init module 88 maps server names for user information to server IP address and port number. Since the user is accessing system 10 via the Internet, the system recognizes the user as being at a remote site.

For authentication purposes, shell-init module 88 is directed to a cluster of central authentication servers. In particular, user entitlement level and user preference profiles are attained from the user's branch server 102 or a master entitlement server 116 of central server(s) 110. Preferably, shell-init module 88 will point to the branch server 102 to which the user preferably logged in to attain a user entitlement level and user preference profile. If this information is unavailable, shell-init module 88 will point to the master entitlement server 116 to attain a user entitlement level and user preference profile. Shell-init will always point to branch server 102 for, e.g., financial adviser specific client data, SMTP e-mail, etc.

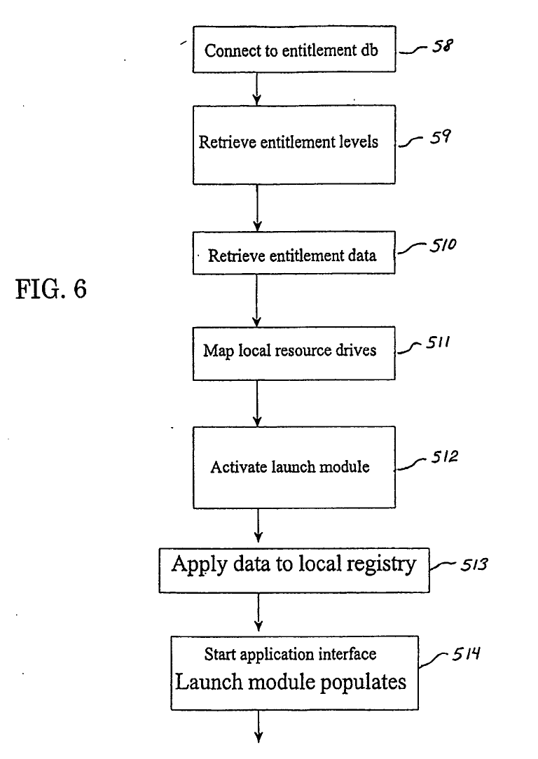

Next, turning to FIG. 6, at step S8, shell-init module 88 connects to an entitlement database, located on a server within system 10. Access to user entitlement level is based on the user identity input at authentication. Shellinit module 88 attempts first to access a user's branch database 106, which includes an entitlement database, to determine this information. If unable to do so, system 10 has a failover to a central server 110 master entitlement database maintained in master entitlement database 116. The master entitlement database includes duplicate entitlement databases to those in the branches.

Next at step S9, shell-init module 88 retrieves a user's entitlement level. In particular, shell-init module 88 retrieves a list of user identifications for accessing objects from system 10. These identifications are stored for use by browser interface 200.

At step S10, shell-init module 88 logons onto an appropriate server, e.g., branch server 102 or central server 110, and retrieves entitlement data. Shell-init module 88 secures registry entries for browser interface 200, attains a user control list, a batch file for interface launch module 90, and a user's parent branch wire code.

Next at step S11, shell-init module 88 maps a user's workstation local resource drives to a user's directories/files, i.e., distributed file system (DFS), by reading from the user's preferences and substituting variables with wire codes, branch groups and user names as appropriate. DFS may be located in any of host server 100 component servers.

At step S12, shell-init module 88 activates browser interface launch module 90, which runs throughout a user's session. Interface launch module 90 builds browser interface 200 from a user's standard browser, and handles security ticket expiration, user logoff and workstation 20 restorations. With special regard to security ticket expiration, launch module 90 continually monitors a security time ticket and gives a warning to a user when time is about to expire. This functionality is provided by querying password module 92 to determine what time allotment a user may have.

Next at step S13, launch module 90 applies the entitlement data to the local workstation registry, i.e., it removes the local preference profile of the workstation and/or browser the user is using. Thereafter, launch module 90 signals controller 84 to start browser interface 200.

At step S14, controller 84 starts browser interface 200, and launch module 90 populates the user's browser with the user's entitled objects and any other ancillary processes. During this time, launch module 90 retrieves path names of executables to launch from the registry. Some objects execute and are monitored, some execute but are not monitored, and some execute at to logoff. These are monitored by launch module 90 so appropriate action may be taken.

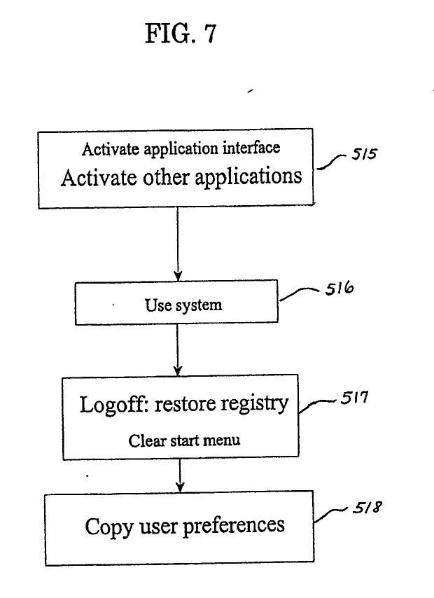

At step S15, shown in FIG. 7, launch module 90 activates browser interface 200, which in turn activates all other objects according to a user's entitlement data.

At step S16, the system is used to conduct various finance-related activities such as advising investors, conduct exchanges on behalf of an investor, chart investment progress, or the like. In this way, the user can provide the investor with timely, proactive financial advice. Launch module 90 monitors a user's time versus a security ticket expiration and notifies a user when his or her time is about to expire. The notification may provide a user with the ability to extend the ticket, otherwise, the user will be forcibly logged off.

At step S17, a user logs-off the system, at which time launch module 90 restores the workstation registry entries that were in place prior to the user's sessions and clears the user's browser.

At step S18, controller 84 copies a user's preferences from local cache to the location from which it attained them as appropriate so a user's changes can be accessed the next time the user logs on.

The authentication system 80 thus described allows a user to access objects according to entitlement level and provides a user preference profile for that user regardless of where workstation 20 is physically located. As such, the system 80 allows a user to log-on from any Internet accessible computer or workstation 20 and have all of the objects, directories/files and preferences available as if they were at their own workstation.

IV. Browser Interface

FIGS. 8A-38 illustrate a browser interface 200 of the invention. Using browser interface 200, a user may access the features of system 10 in a completely Internet-based environment. In this environment, a user may access objects such as those outlined above in section II (i.e., as shown in FIG. 3, a plurality of financial applications 36, a plurality of market monitoring objects 38, and a plurality of additional objects 35), from any personal computer or workstation 20 having Internet access. The ability to have a user access the system using a browser interface 200 provides an advanced technology platform with a stable, fast operating environment, easy accessibility and usability, and the flexibility of remote computing.

Advantageously, browser interface 200 provides a seamless transition between the different objects afforded by system 10 of the invention. The objects available are determined by a user's entitlement level as described above relative to authentication system 80. Browser interface 200 thus acts as a “controlled shell” for a user in that only objects that a user is entitled to are provided to him or her. Based on the type of financial information desired, the user selects the appropriate application(s), function(s) or Web site(s)/page(s) for use, as described in greater detail below. In accordance with the particular user selection, system 10 opens and/or connects to the selected object(s) and the user is able to view the object(s) at workstation 20 through the browser interface 200. Object data displayed may be from any component server of host server 100, i.e., branch or central servers. Access to Internet investment product server(s) 124 or any other outside source that requires heightened security, may be accessed (or filtered) through firewall 120 from the Internet 121 (FIG. 1).

As discussed above relative to system 10, where a user is connected to a host server 100 via the Internet 21, connectivity is provided by conventional TCP/IP sockets-based protocol. In this network-based system, a workstation 20 may be any computer, stationary or portable as described above, that has Internet access such as an Internet service provider outside of the system 10 to establish connectivity to host server 100 of system 10. In this environment, all data is preferably encrypted, e.g., with 128-bit encryption techniques, to ensure account integrity will be maintained.

Referring to the details of FIGS. 8A-38, an exemplary browser interface 200 is described. It should be recognized that the particular objects disclosed may vary depending on a user's entitlement level. Furthermore, the particular appearance of browser interface 200 may vary according to a user's preference profile, e.g., each user's toolbar may have buttons in different positions, have different objects viewable from a menu, etc.

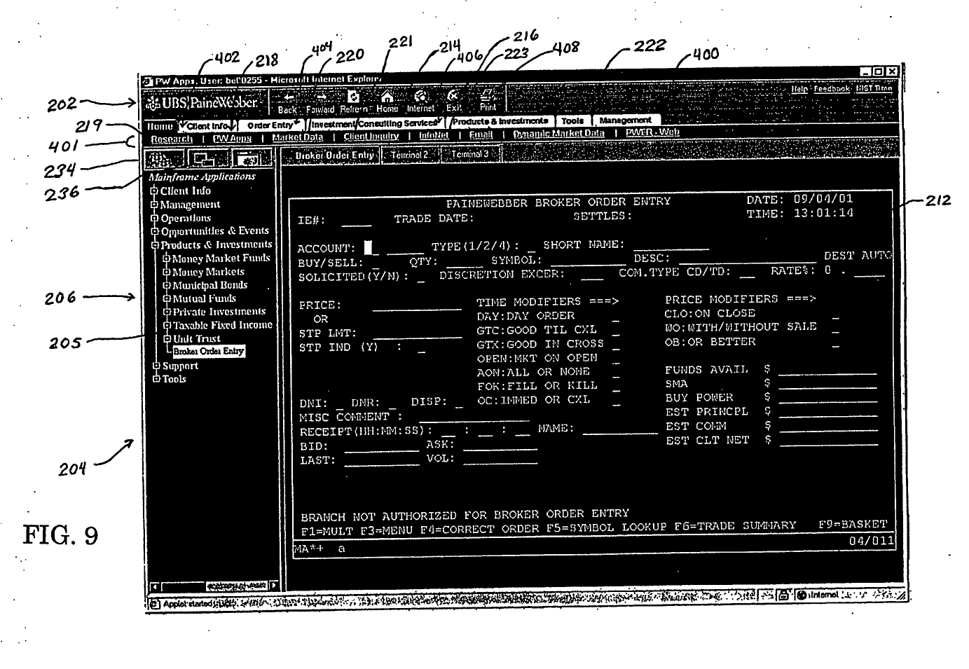

Referring to FIG. 8A, an authentication login 222 is displayed on a user's browser. Login 222 is presented to a user upon accessing system 10 by inputting an appropriate URL in the user's browser, and is operable with authentication system 80 of system 10, as discussed above, to allow a user to enter system 10 using his or her user name and password. Where a successful logon has been completed, the user is presented with a browser interface start window 201 such as the simplified screen display of available feature shown in FIG. 8B. As used herein, the interface 200 shown in FIG. 8B is a simplified version to that shown in FIGS. 9-38 and is not representative of the complete feature set of browser interface 200.

Referring to the more detailed drawings in FIGS. 9-38, the browser interface 200 includes:
a navigation toolbar 202;
a task menu 400;
an object menu 401;
an action menu 204; and
at least one view window 212.

Toolbar 202 may include standard browser features such as back, forward, refresh/reload, home and print. Additionally, toolbar 202 preferably includes an Internet selection 214 and exit selection 216. Internet selection 214 allows a user to access the Internet in general for conventional search engine searching of the World Wide Web. For example, a user may conduct searches for investment information, background information, breaking news that affects investments and the like on search engines as Yahoo and Excite. General Internet access also allows a user to communicate with other users and with clients via e-mail packages such as provided by Microsoft Outlook. This provides means to access the Internet, send e-mail and search at least one search engine. If necessary, access to the Internet 121 may be filtered through firewall 120 of system 10 for added security. Exit selection 216 to allows a user to successfully logoff of system 10.

The toolbar 202 also preferably includes a scratchpad application selector 207, which serves to maintain focus on accounts or positions by moving information between objects of system 10. Accordingly, scratchpad 207 relieves the user from having to continually re-enter data. Although preferred toolbar features have been disclosed, it should be recognized that any number of additional features and/or selections might be added in a known fashion as desired.

The task menu 400 is preferably presented as a series of command tabs, each of which provides access to different objects or features of the browser interface 200. The task menu organizes the system features by the broad tasks that a user, such as a broker or financial analyst, encounters in performing their daily activities.

The object menu 401 provides the user with a user-selected link to each financial application or information resource that is associated with the task 400 presently selected by the user. Each task 400 is associated with a different object menu that is viewable when that task is selected by the user.

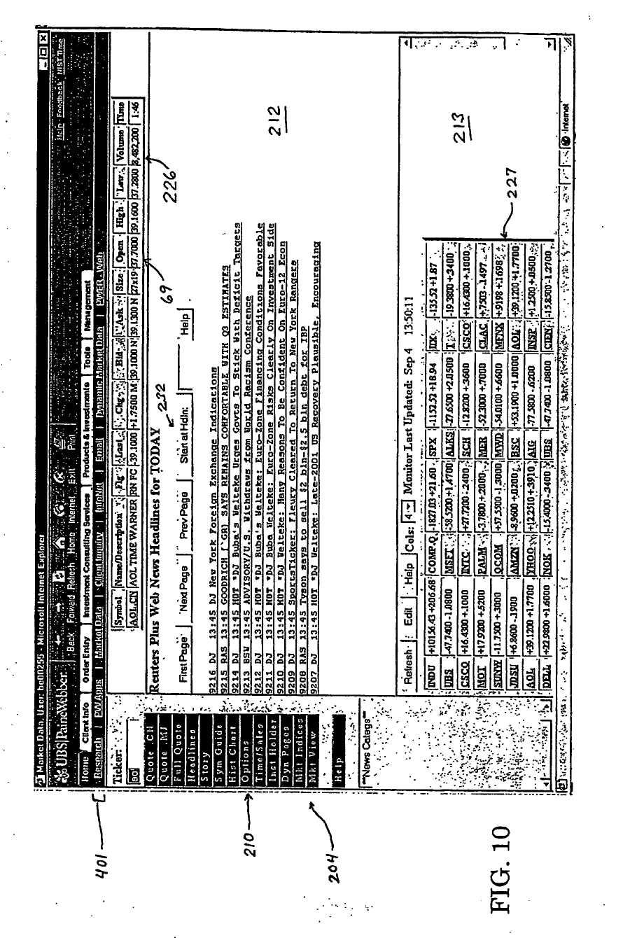

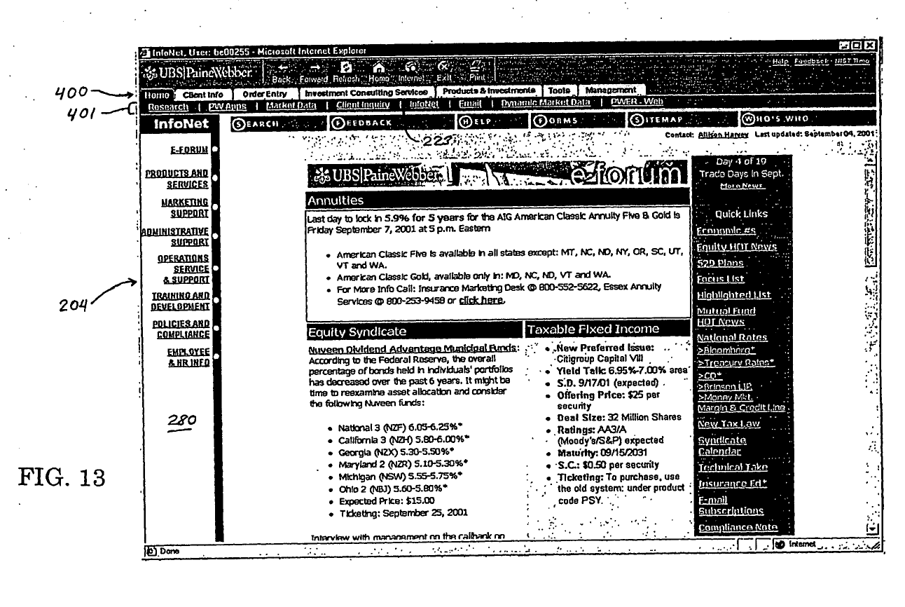

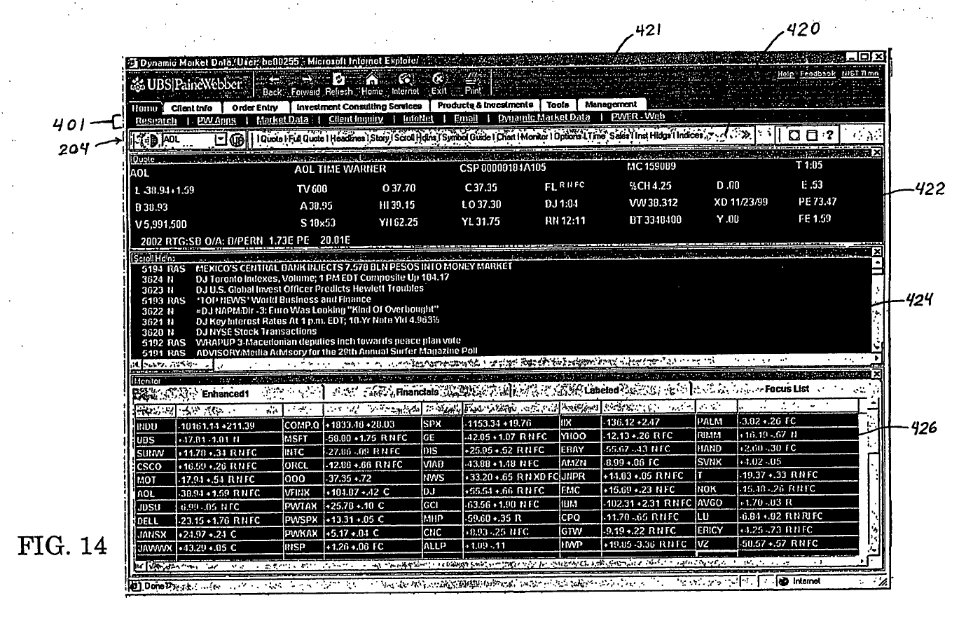

The action menu 204 varies depending on the object 401 selected by the user. In one case, as shown in FIG. 9, the action menu 204 presents a menu of application operations (i.e., application menu) 206. In another case, as shown in FIG. 10, the action menu 204 presents a market data function menu 210. In still other cases, the action menu 204 can be a navigation menu 280, as shown in FIG. 13. The action menu 204 can be positioned at a variety of positions on the screen, such as the width-wise position of the operation menu 420 shown in FIG. 14. The view window 212 is used to present information from the associated object(s) selected by the user.

Using the above-noted task bar 400 and object menu(s) 401, a user may select an application, function or information resource presented by browser interface 200. Upon activation of any selection, browser interface 200 typically provides the action menu 204 of possible actions, operations, functions or information content available for the particular selection. Upon selection of an object, the information associated therewith is displayed in at least one view window 212. If the object activated does not contain a number of user-selectable actions thereby obviating the need for a menu, the view window 212 may display the information without an associated action menu. Each entry in the action menu 204 can be a hypertext link to a function or other object having information for display or a link to a menu 205 of sub-items, e.g., as shown for products & investments in FIG. 9. Selection of a particular operation from menu 204, 205 will force activation and/or display of the associated information in at least one view window 212 adjacent to the action menu 204.

As shown in FIG. 10, more than one view window 212, 213 may be displayed at one time by selecting split screen function 236 (FIG. 9) and activating multiple objects. For instance, in FIG. 10, a first view window 212 displays a market data headlines view function 226, while a second view window 213 displays a market data monitor list function 227. Similarly, one view window 212 may display a market data function, while a second view window 213 displays a financial application. Every view window 212, 213 may include conventional scroll bars as necessary.

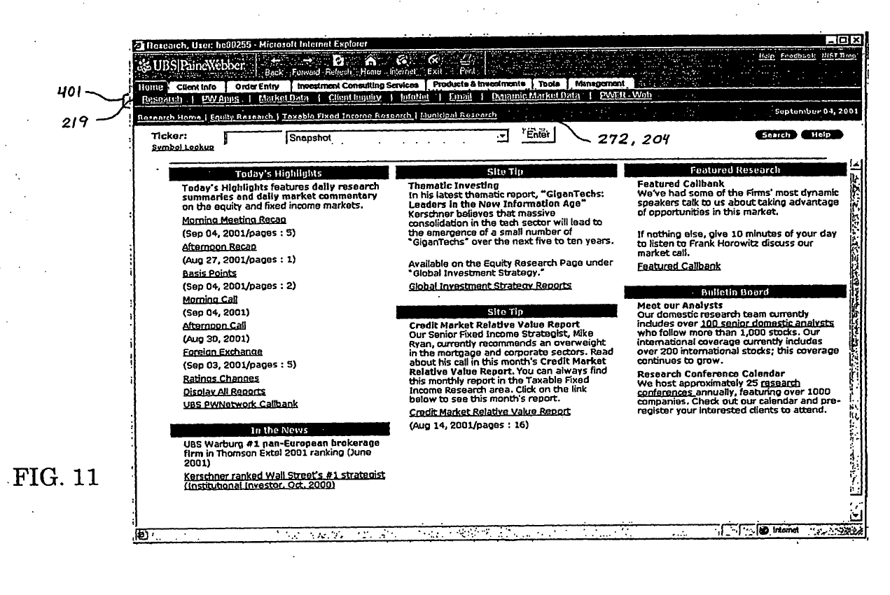

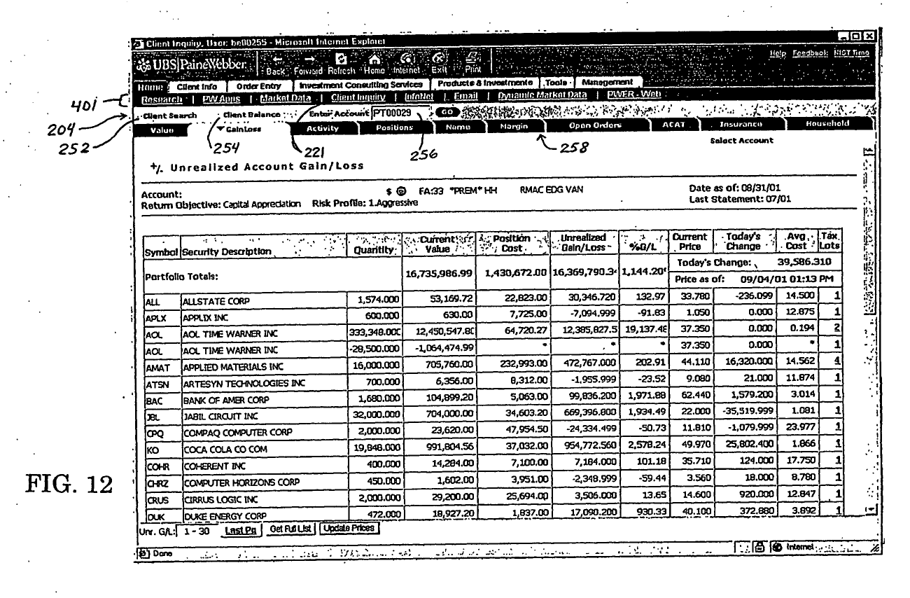

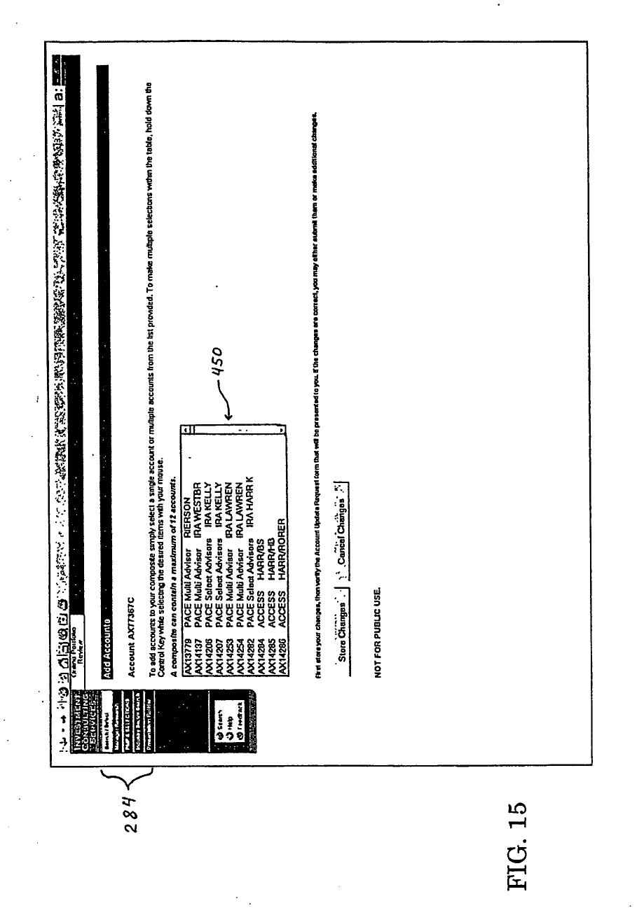

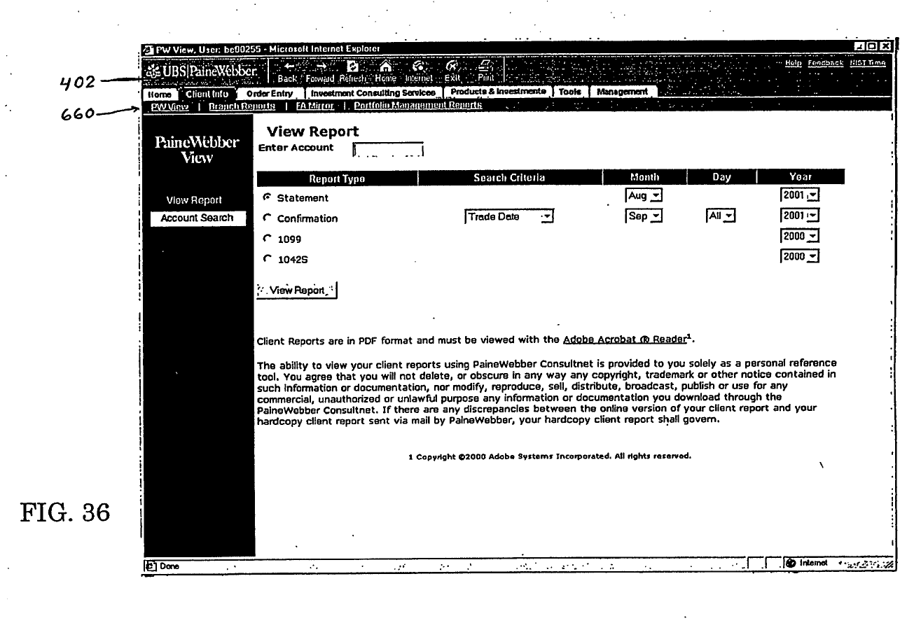

The following description sets forth exemplary features of browser interface 200 such as financial application objects 36, market monitoring functions 38, additional objects 35, and additional browser interface features. The application objects may include research objects for researching investments (FIG. 11); client inquiry objects for investigating client accounts, positions, and the like (FIG. 12); a browser-based information network that provides proprietary product and administration information (FIG. 13); dynamic market data (FIG. 14); various objects for investment consulting services (FIGS. 15-35); and a variety of other objects (FIGS. 36-38).

Main Menu

A.1 Applications:

FIG. 9 shows the action menu 204 instantiated as an application menu 206 for a plurality of functions or operations provided upon activation of the “PW Apps” link 218 on the object menu 401. These functions generally provide investor account data, online statements, transaction confirmation, IRS 1099's, investor account information, portfolio management, TFI and MUNI inventory, security cross references, and the like. The selections of application menu 206 may include client information functions, management functions, opportunities and events functions, products and investment functions, support functions, and tool functions. Each selection may include a drop-down menu 205 of subselections. For instance, product and investment sub-selections include money markets, municipal bonds, mutual funds, private investments, taxable fixed income, unit trust and broker order entry. FIG. 9 shows a broker order entry function in view window 212 that has been selected from application menu 206.

Exemplary sub-selections for some of the application selections include:

Client info: account inquiry, householding of a family or related accounts, online client services, portfolio management, client contact and portfolio information, security cross reference, stock records, 1900 system, client database, client and account review, client statement system, dividend reinvestment, late pay-margin interest, managed account billing, client account balances (i.e., MoneyLine), and financial framework (a financial planning application). One particular ‘client info’ application is an investor monitoring system which allows a user such as a financial adviser to monitor specified investor accounts and activity, e.g., online investor transactions, and allows the user to monitor and participate in investor-mediated transactions on a real-time basis. For instance, after tracking an account activity, a user may send e-mail to a client and make recommendations. Further, a user may place orders and conduct other transactions for a client via applications menu 206, e.g., placing an order as shown in FIG. 9. Here, host server 100 is linked via conventional communications channels to a system for investor trading such as an online transaction forum, or some other investor transaction system such as a telephone-assisted investment forum. In such instances, host server 100 receives real-time communications regarding investor-mediated transactions. These are, in turn, transmitted to a user's workstation 20 on a real-time basis over Internet 21. Because the user is notified of an investor's transaction status, he or she can intercede and/or act in a proactive manner; for example, by contracting the investor if it appears that the investor needs assistance with a transaction. In this way, the user can protect an investor outside of the system of the present invention from executing deleterious financial transactions. The monitoring system also alerts a workstation 20 within the system where an investment transaction forum, such as those described above, blocks an investor from entering an investor-mediated transaction, or alternatively allows an investor to successfully complete a particular transaction.

Management: trade monitor operations problem ticket tracking and reporting system, and client account cross reference lookup/routing used to maintain audit of account number changes.

Opportunities and Events: new and old corporate actions; a financial adviser may view his or her client account balances (called FYIE), maturing holding, commissions revenue history, etc., and an enhanced version of ME that provides the financial adviser with upgrade recommendations for his clients particular to swap or upgrade security recommendations.

Support: account maintenance fee, aged check system, disbursement confirmation system, fed funds transfer system, messages, securities information inquiry and security glossary lookup.

A.2 Market Data:

FIG. 10 shows the action menu 204 instantiated as a market data function menu 210, which is provided upon selection of the market data link 220 on the object menu 401. Market data function menu 210 provides a plurality of market data functions for selection. Generally, market data functions may provide real-time access to quotes (e.g., last, bid, ask, NASDAQ, Commodities, etc.), news, historical information (e.g., daily, weekly), charting, dynamic market indicators (e.g., percent up and down, point gainers and losers, foreign exchanges, financial futures, most active trades and the like), news from popular services and the Dow Jones, market views, a fixed income calculator, symbol guide and news and limit alerts as well as the ability to customize charting features and web pages.

Each market data function presents real-time market data in a useful manner. The market data function menu 210 includes a number of functions that allow a user to review market data. For example, a user can obtain headlines, and specific information on a security such as a quote, full quote, today's headlines, options, time and sales, institutional holders, and the like. Other optional information such as a market snapshot of indices, market view, an overview of several exchanges (i.e., NYSE, NASDAQ, and AMEX), sector quotes, and news categories may also be accessed. Historical charts can be also plotted for a given security. Preferably, the market data functions access market data server 114 (FIG. 1) on a real-time basis, e.g., one that accesses Quotron by Reuters. As previously noted, the market data functions may access other market data servers, maintained as part of branch server 102. The information may be updated by clicking on a refresh button on toolbar 202.

Using mechanisms well known to those with skill in the art, any relevant market information may be accessible within the market data functions. For instance, FIG. 10 shows a market data function's headlines function view window 226 for the stock AOL.

Advantageously, the market data functions permit customization of any of the displayed information and allows for multiple representations on a single screen. As shown, each view window 212, 213 may also provide functionality selections 232 particular to that view window.

Once connected, data flows in real time to the user's market data functions. Changes are indicated on screen and the user has the ability to set options such as colors, font sizes, audible alerts, blinking, etc. that will be saved as part of his or her preference profile. The receiving of the market data updates is frequently called “dynamic, real-time, streaming quotes”. Once the user obtains financial information of interest, he or she can utilize this information to advise an investor, conduct exchanges on behalf of an investor, chart an investor's investment progress, or the like. In this way, the user can provide the investor with timely, proactive financial advice.

An additional functionality of a market data function may include a customized quote window 69, which may contain information such as last price, bid, ask, high, low, etc. Quote window 69 may be continuously displayed on video display 24 as part of browser interface 200, i.e., it is fully integrated into all data displayed from any component server of host server 100 from which data is retrieved or sent. The symbol in the quote window 69 may also be dynamically linked to the symbol focused on by a user's cursor, or mouse 28.

A.3 Research:

In FIG. 11, the action menu 204 is instantiated as a research menu 272 that is provided upon selection of the research link 219 from the object menu 401. Research menu 272 includes a number of research functions for researching investment information. Exemplary research menu 272 selections include main menu or home, equity research, taxable fixed income research, and municipal research. A exemplary research function is the proprietary PaineWebber PWER II system, which searches for companies by, for example, industry, price, P/E ratio, growth rate and rating, utilizing multiple search methods such as by date, author, title, industry, subject code, ticker system, company name, report type and country.

A.4 Client Inquiry:

In FIG. 12, the action menu 204 is instantiated as a client inquiry menu 250 that is provided upon selection of the client inquiry link 221 from the object menu 401. Client inquiry object selections allow a user to search for a client 252, obtain a client balance 254 and select an account 256 for investigation. A user may also evaluate an account in a variety of ways through account evaluation menu 258, which also forms part of action menu 204. Menu 258 may include evaluation selections of, for example activity, unrealized gains/losses (shown in FIG. 12), statement household (i.e., client specific account categorization), insurance, realized gains/losses and value.

A.5 InfoNet:

In FIG. 13, the action menu 204 is instantiated as an information network (called InfoNet) navigation menu 280 that is provided upon selection of the “InfoNet” link 223 from the object menu 401. FIG. 13 also shows a start Web page for InfoNet. InfoNet is a proprietary browser-based information network that enables users to conduct searches for ideas and information, provides links to related pages (for example, a sales idea, a marketing brochure, etc.), provides subscriptions to popular publications and research, access to third-party news, information and sales ideas, and allows a user to fill out and forward forms to an investment forum outside of the system 10. In particular, the InfoNet menu 280 may provide selections for an E-forum for employees, corporate products and services, marketing support, administrative support, operations support, training and development, employee information, policies and compliance and correspondent service corporation.

A.6 Dynamic Market Data:

In FIG. 14, the action menu 204 is instantiated as a market data menu 420 that is provided upon activation of a dynamic market data link 421 from the object menu 401. The market data menu 420 enables the user to select a particular equity and obtain a variety of information about it, such as a real time stock quote 422 and stories pertaining to the stock. The user can also select to see a variety of the most recent financial news headlines 424 obtainable from one or more third party or internal sources; set up and monitor a plurality of stocks 426; obtain detailed news stories about a stock via menu selection 428; and chart a stock via menu selection 432.

Investment Consulting Services

B.1 Online Portfolio Review:

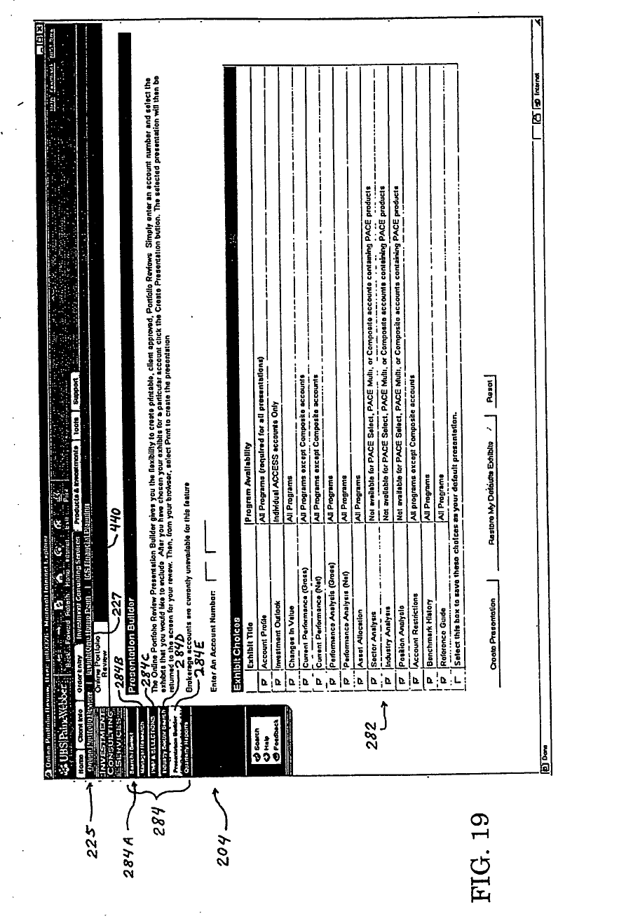

FIGS. 15-31 show various links available under the investment consulting services (ICS) tab 406 of the task menu 400 (seen in FIG. 9 and FIG. 19). These links provide access to the following objects: an online portfolio review application 225; Insight One™ web site 227; ICS financial planning application 440; and ICS trading application 442.

The online portfolio review (OPR) application 225 provides users with enhanced client reporting over daily and extended timeframes, and provides a tool that reflects asset allocation for grouped or composite accounts. It also compares account holdings to selected indexes. The OPR application may be used for both managed accounts, e.g., by a financial advisor, and non-managed accounts. Preferably, the OPR application is used for managed accounts. FIG. 19 illustrates an action menu 204 instantiated as an online portfolio review menu 284 that is provided upon activation from the online portfolio review application 225 on the object menu 401. From portfolio review menu 284, a user may select functions such as:
Search and select (284A)—enables a user to select one or more accounts and invoke a number of portfolio review functions to create exhibits, for example, client presentations.
Manager research (284B)—provides information about product managers.
PMP & Selections (284C)—a portfolio management program.
Industry sector search (284D)—for obtaining exhibits regarding a particular industry sector.
Presentation builder (284E)—creates presentation exhibits based on a client portfolio.

More specifically, the search and select function 284A enables users to create composite accounts, as shown in the screen shot 450 of FIG. 15 wherein an analyst or other user has created an example composite account no. AX77367C. A composite account groups together related accounts across various financial products to create a single householded account.

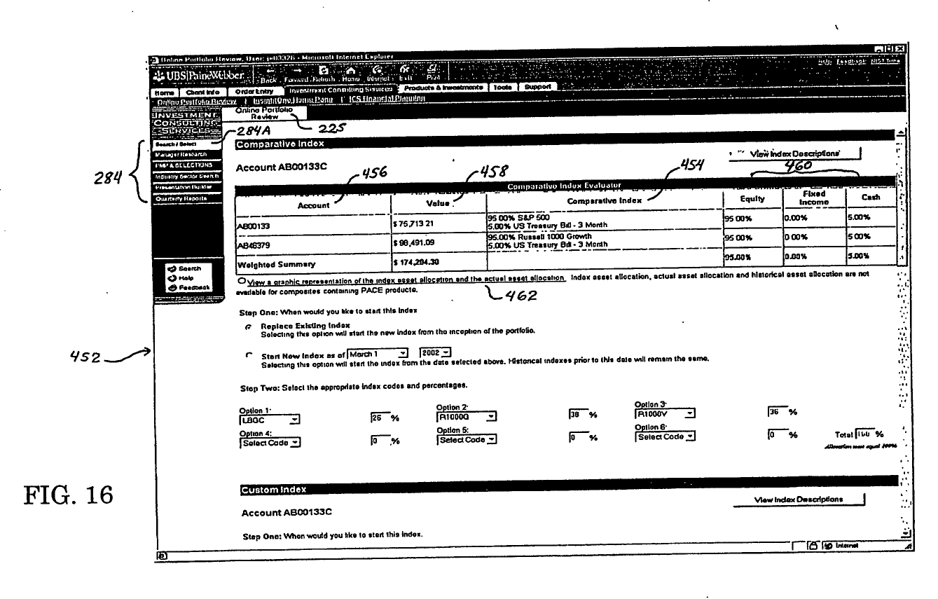

Bringing unique accounts together presents a difficulty in terms of choosing a representative comparative index which can be used to evaluate the composite account. This is rectified by the search and select function 284A which allows the user to select a comparative index evaluator 454, as shown in the screen 452 of FIG. 16. The screen 452 displays the account number 456, value 458, comparative index 452, and the index classification 460. From this screen the user will be able to select a comparative index based on the information displayed, and will also have a hyperlink 462 to view a graphical representation of asset allocation.

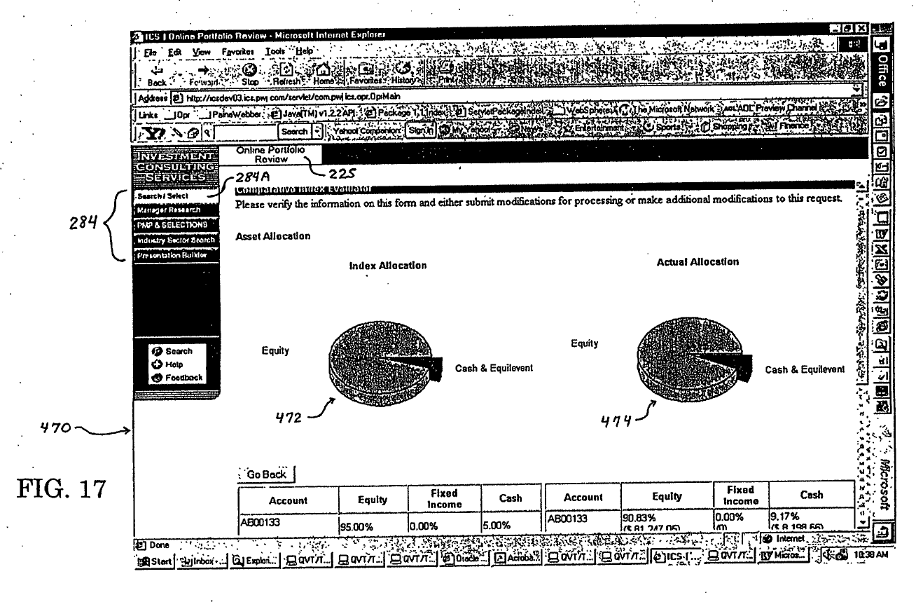

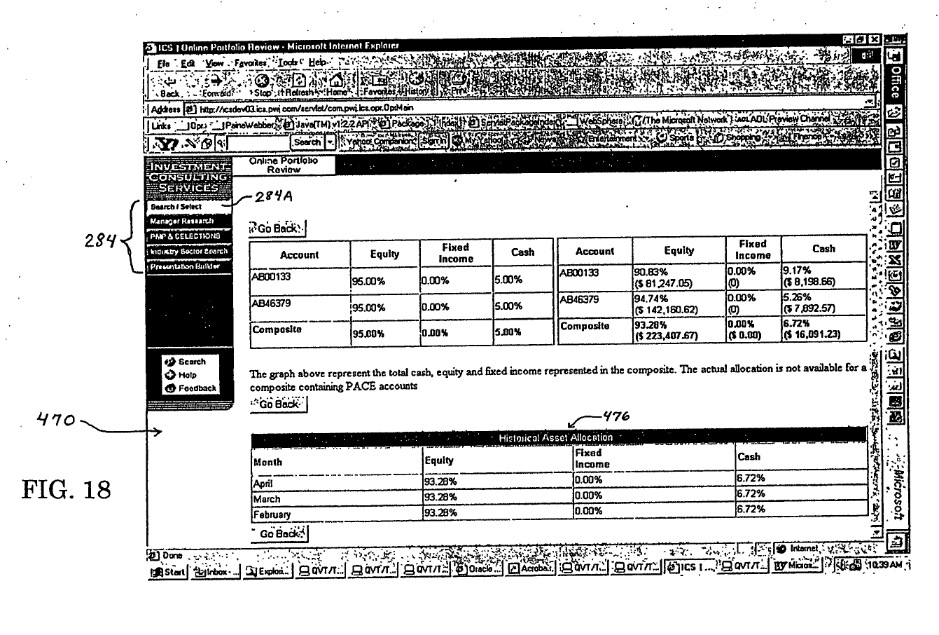

If the user chooses to view the graphic representation, the user will be brought to an asset allocation evaluation tool 470, depicted by the screen display of FIG. 17. FIG. 17 graphically represents (using a pie chart in this case) the asset allocation of the selected index 472 and of the composite account 474. FIG. 18 shows a continuation screen of the asset allocation tool 470, wherein the asset allocation is tabulated, as shown. Historical asset allocation 476 may also be stored and presented.

The presentation builder feature 284E provides the user with printable portfolio reviews. Examples of the types of displayable and/or printable reports (alternatively referred to as exhibits) 282 are shown in FIG. 19.

Another aspect of the presentation builder tool is that it also enables financial advisors to select and assemble marketing and advisory materials from a wide range pre-selected materials relating to a variety of product areas into customized slide presentations for clients and prospective clients. The tool enables financial analysts to increase the number of presentations to clients while reducing the time and effort required to accomplish this.

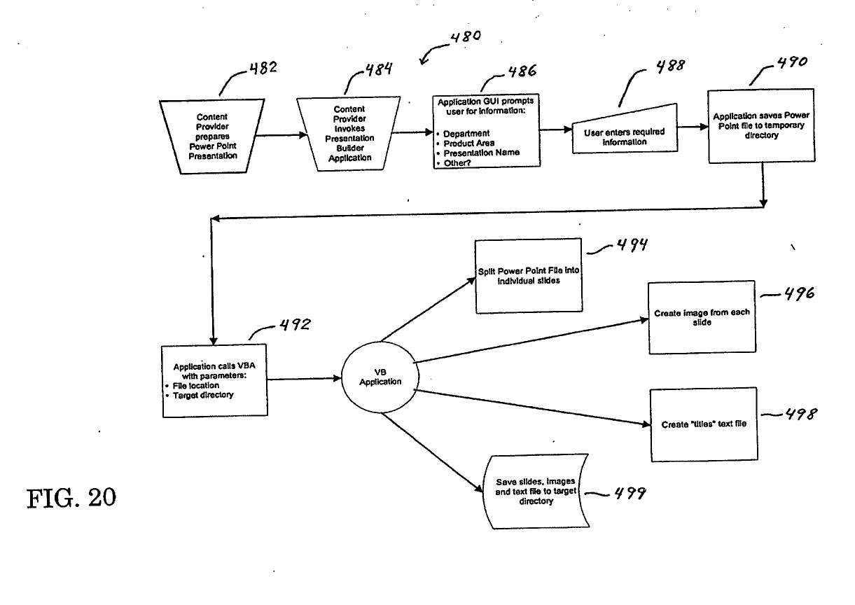

FIG. 20 shows a process 480 for uploading slides to a centralized database. Certain users have rights as “content providers” which enables them to load presentations into the presentation builder database. A presentation is created in Microsoft Power Point™ (step 482), and uploaded as a power point (PPT) file to a temporary directory along with tombstone information entered by the user (steps 484-490).

The tool then calls a visual basic application (step 492) which splits the file into individual slides (step 494) and creates a separate image from each slide (step 496). This allows the tool to display and manipulate the slides individually. The tool reads each slide's title from the “title” object embedded in every PPT slide and creates a corresponding text file (step 498). If the “title” object is empty, a system-generated title will be used. Once the slides are loaded in the database, they can be accessed to create customized presentations.

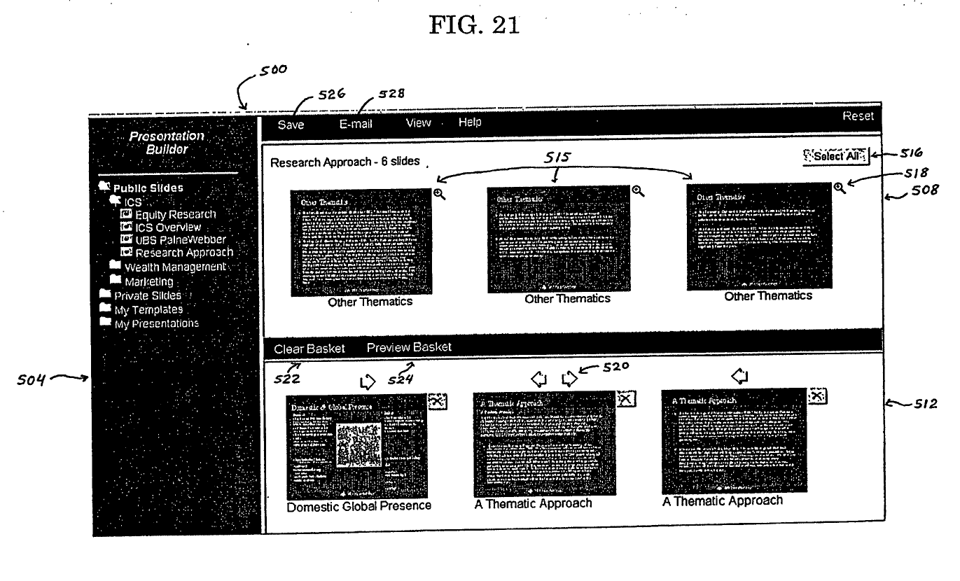

FIG. 21 shows a slide display screen 500, which comprises three main panels: a folders panel 504, a slide selection panel 508 and a basket panel 512. The slide selection panel 508 shows images of the slides in the presentation selected by the user from a public slides folder or a private slides folder. The name and number of slides of the selected presentation are shown on the upper left corner of the panel. This text will also indicate if the presentation is “grouped”.

Users click on a slide 515 to select it. A selected slide is automatically transferred out of the slide selection panel 508 and into the basket panel 512. The “Select All” button 516 on the upper right corner will transfer all the slides in the slide selection panel 508 to the basket panel 512. Once done selecting slides from one presentation, users can open and select slides from another presentation.

The illustrated embodiment shows that the user opened a presentation entitled “Research Approach” from the ICS sub-folder in the Public Slides folder. This presentation contains 6 slides. Of the six slides, the user selected three, which are shown in the basket panel.

Users can enlarge each slide in the selection panel by clicking the magnifying glass icon 518. A scroll bar will show on the slide selection panel 508 if the number of slides requires it.

The basket panel 512 contains images of the slides selected by the user from the various presentations available in the system. Except for the first and the last slides in the basket, each slide has two arrows 520 above it which allow the user to change the placement of the slide within the presentation. The arrow pointing to the right moves the slide to the next position. The arrow pointing to the left moves the slide to the previous position. Since the first slide in the basket can only move to the next position, it only has one arrow pointing to the right. Conversely, the last slide in the basket only has one arrow pointing to the left since this slide can only move to the previous position.

Options are also available for clearing 522 the basket 512, which removes all slides, and previewing 524 the basket, which allows users to navigate through magnified, or scaled down, images of the slides in the Basket Panel.

The save function 526 allows the user to save the presentations collected in the basket panel in either the “my presentations” folder or “my templates” folder, the latter being intended for temporary storage.

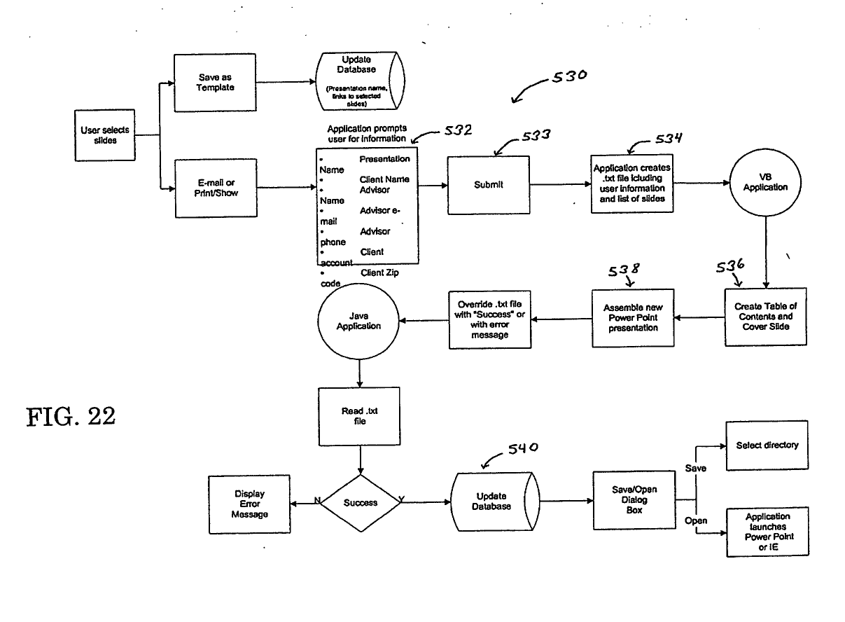

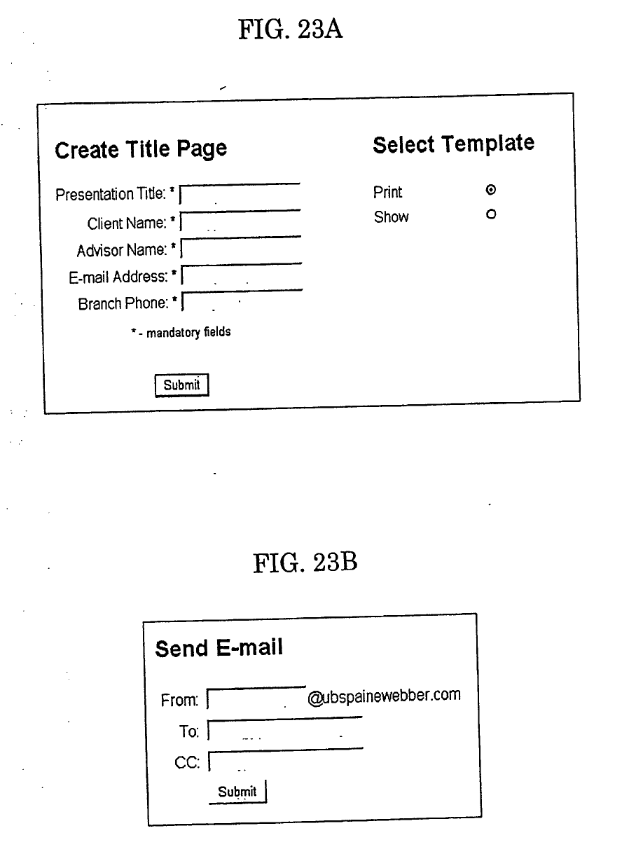

The e-mail function 528 allows the user to send a presentation to recipients via electronic mail. FIG. 22 shows the download process 530, and FIGS. 23A & 23B show various user-interface screens encountered to e-mail a presentation to a client.

In the event the user selects to e-mail, print or preview the selected slides, the tool will prompt the user for pertinent information such as presentation name, client name, advisor name, advisor e-mail, advisor phone, client account and client zip code, as shown in FIG. 23A and indicated at steps 532-534 in FIG. 22. Once the information is entered a “table of contents” slide and a “cover” slide are generated by the system (step 536). The application then proceeds to assemble the slides into one single Power Point file (step 538). If this process is successful the database is updated with client information (step 540).

Whenever a PPT file is created, the tool logs the user name, the date, the client's name, and the contents of the presentation (i.e., links to the slides included in the presentation) into its database for audit purposes (step 540). E-mails are also recorded.

B.2 InsightOne Web Site:

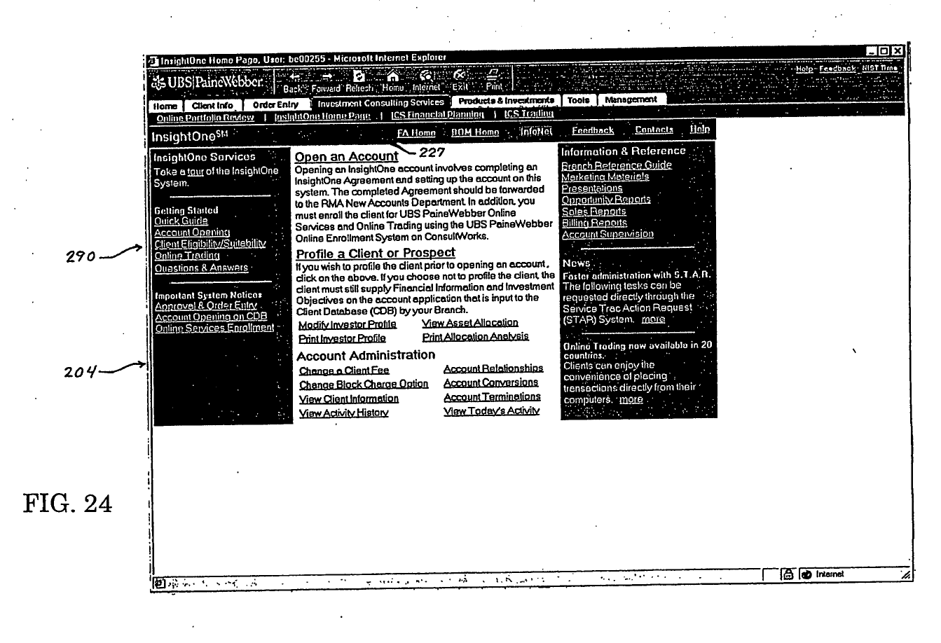

FIG. 24 shows the action menu 204 instantiated as an InsightOne menu 290 and web site home page that is provided upon activation of the InsightOne Home Page object link 227. InsightOne is a Web site that provides a non-discretionary client brokerage program that performs trade based on payment of a single annual fee calculated from eligible assets.

B.3 ICS Financial Planning

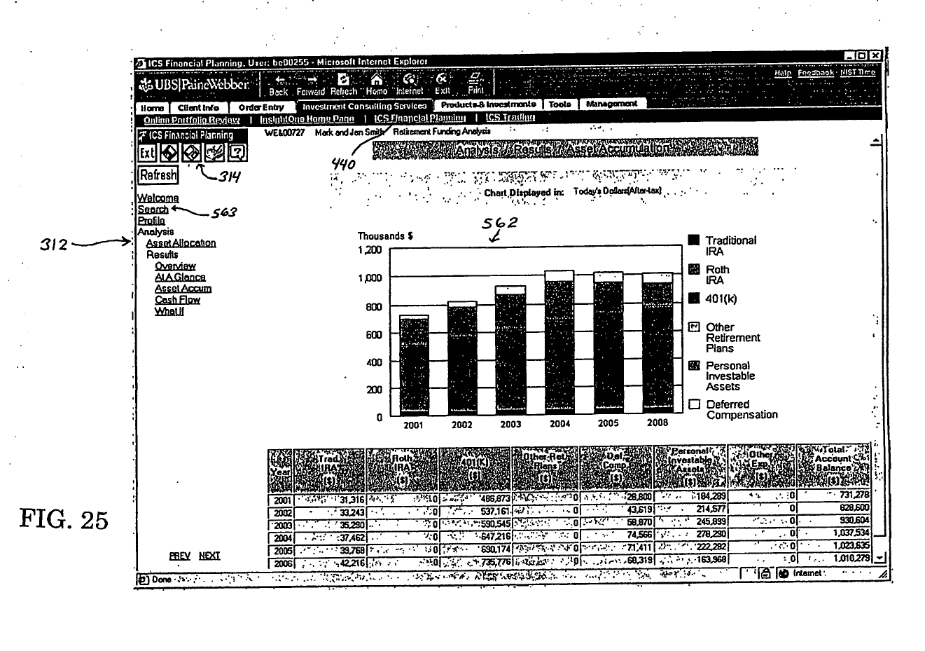

FIG. 25 shows a financial planning application 440 accessible via the object menu 401. Upon activation of this selection the action menu 204 is instantiated as a financial planning menu 312. The financial planning application enables through a user to profile clients and present appropriate asset allocations and investment alternatives. Financial planning application 440 displays an investor's current asset allocation and suggests an alternative allocation based on risk tolerance. It also analyzes progress toward goals using established growth rate assumptions; allows for customization of asset allocation and change in certain variables to assess the impact on an investor's financial situation; and allows for the assessment of the impact of inflation and other factors on investment results. The financial application can also be used for a retirement funding analysis, that is, to analyze the retirement savings and income needs of clients who are planning for retirement or who are already retired; for an education funding analysis, which address the funding needs for preparatory, undergraduate, and graduate schools; or other similar analysis.

The financial planning menu 312 provides selections to welcome a user and/or client and provides instructions on use of the application 440, search for client information, generate a client profile, and analyze a client portfolio. Under the analysis selection, a user may select from asset allocation to determine where a client has his or her investments and results. The results selection also includes selections such as overview, at a glance, asset accumulation, cash flow, and “what if”. “Overview” allows a user to generally review a client portfolio. “At a glance” provides a summary of the client portfolio. “Asset accumulation” provides a client's account(s) gains and analyzes progress toward goals using established growth rate assumptions. For example, FIG. 25 shows a chart 562 which projects asset accumulation over time on the basis of specified assumptions (not shown). The charts can be prepared based on composite or householded accounts in which an individual or family may have a number of separate accounts but wish to view the aggregate portfolio (i.e., across all accounts) over time. The user selects the accounts which form the basis for the chart via the “search” menu selection 563. “Cash flow” provides an indication of the liquidity of the client's assets. “What if” allows a user to suggest an alternative allocation based on risk tolerance. It also allows for customization of asset allocation and change in certain variables to assess the impact on an investor's financial situation; and it allows for the assessment of the impact of inflation and other factors on investment results.

Financial planning application 440 also provides icons 314 for exiting, saving, printing, help and refreshing the application.

B.4 ICS Trading (ICST)

ICST is a web-based application accessible from the ICS trading link 442 on the object menu 401. The application facilitates trade creation and allocation for users by streamlining navigation via browser based front-end screens. The ICST application gives users the ability to perform a trade criteria search by identifying particular accounts to which they may perform balancing functions by (a) single accounts, (b) security and (c) model balancing (by portfolio percentage). The ICST system also includes trading functions for manual order submission or electronic order submission (EOS), order execution and trade status capability.

Single account balancing allows the user to view the holdings in a single account and create orders by changing the target quantity. This results in an order quantity, for either buy or sell, which can be created and submitted. Security balancing is used by users to establish new or modified targets (holding %) for multiple accounts. For example, the user will identify all or a subset of accounts and specify that all accounts should hold 3.5% IBM. The holdings are analyzed relative to the target and orders to buy or sell are created at the account level and are blocked by security at execution time. Model balancing operations are used across or multiple accounts. Here, the user creates models that contain a list of securities and a corresponding weight (% to hold). When accounts are balanced against a model, the holdings and corresponding weight (relative to the portfolio) are compared with the securities and weights in the model. Orders to buy and sell are created as follows:
(1) securities in the model, but not in the account are bought. The quantity is derived from the weight in the model;
(2) securities in the account but not in the model are sold; and
(3) securities found in both the account an the model are adjusted to the appropriate weight, resulting in either a buy or sell.

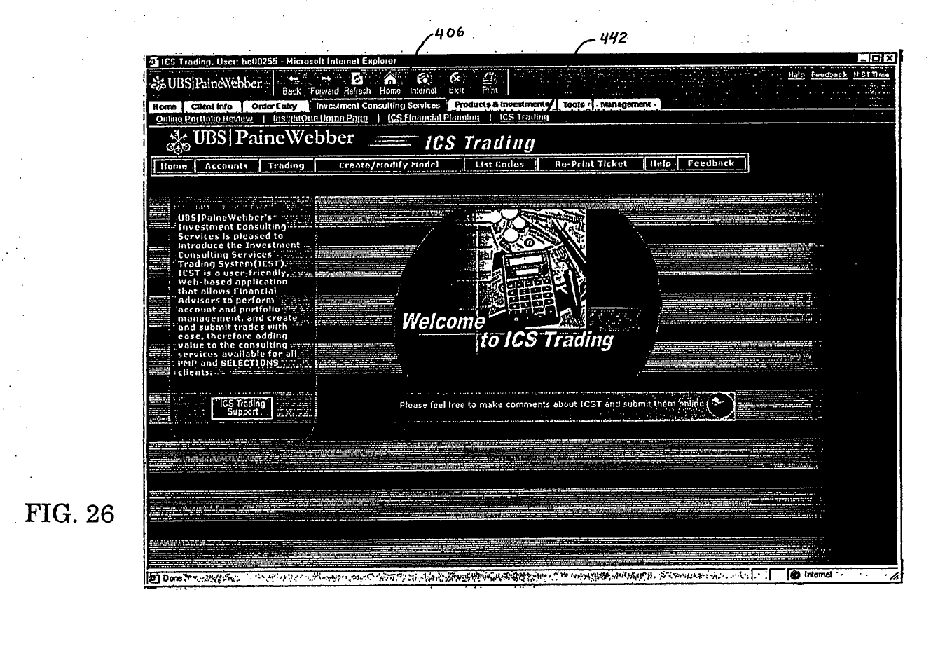

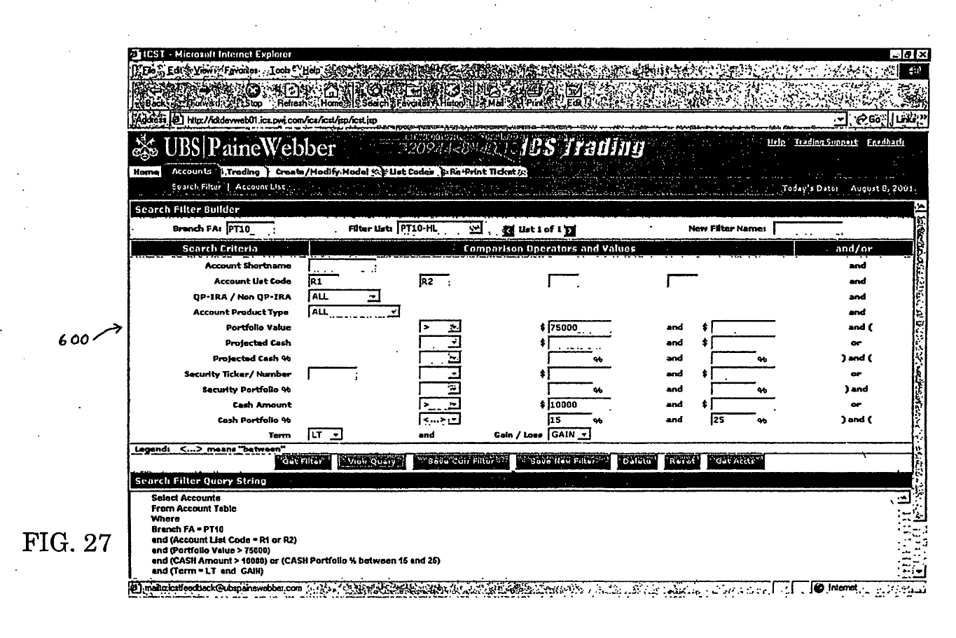

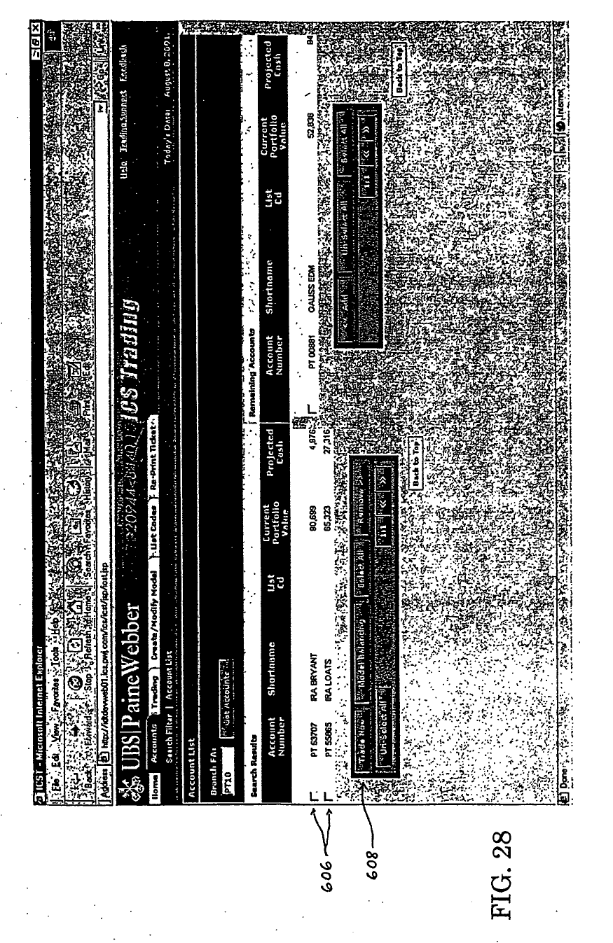

FIG. 26 shows the welcome screen. FIG. 27 shows a search filter screen or tool 600 which can be used to identify one or more accounts of interest. FIG. 27 is illustrative only, and the search parameters need not be exactly as shown. The search results in a subset (i.e., one or more) accounts being selected, as exemplified in FIG. 28. Menu 604 allows accounts to be added or deleted from this list.

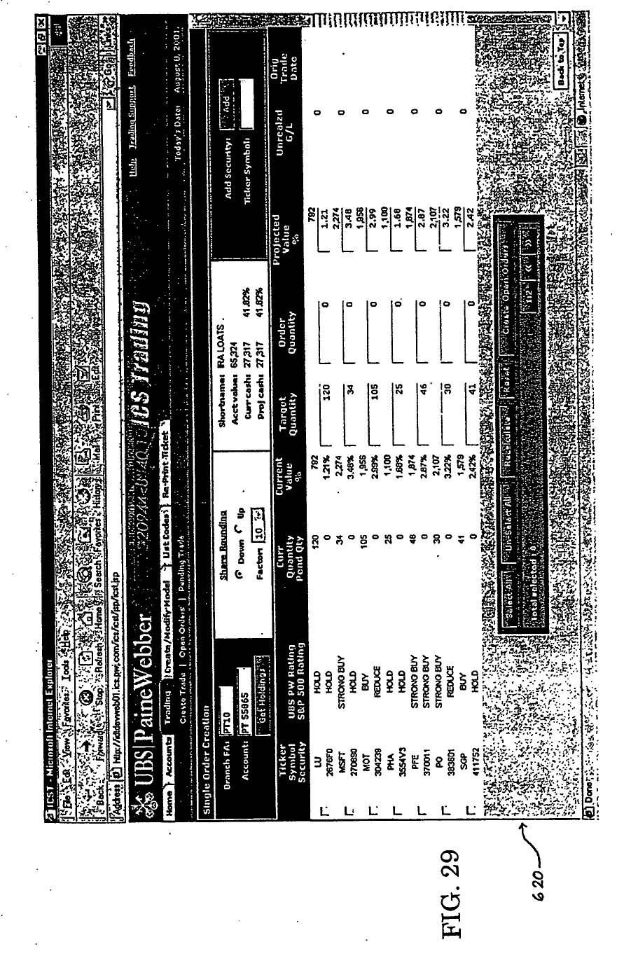

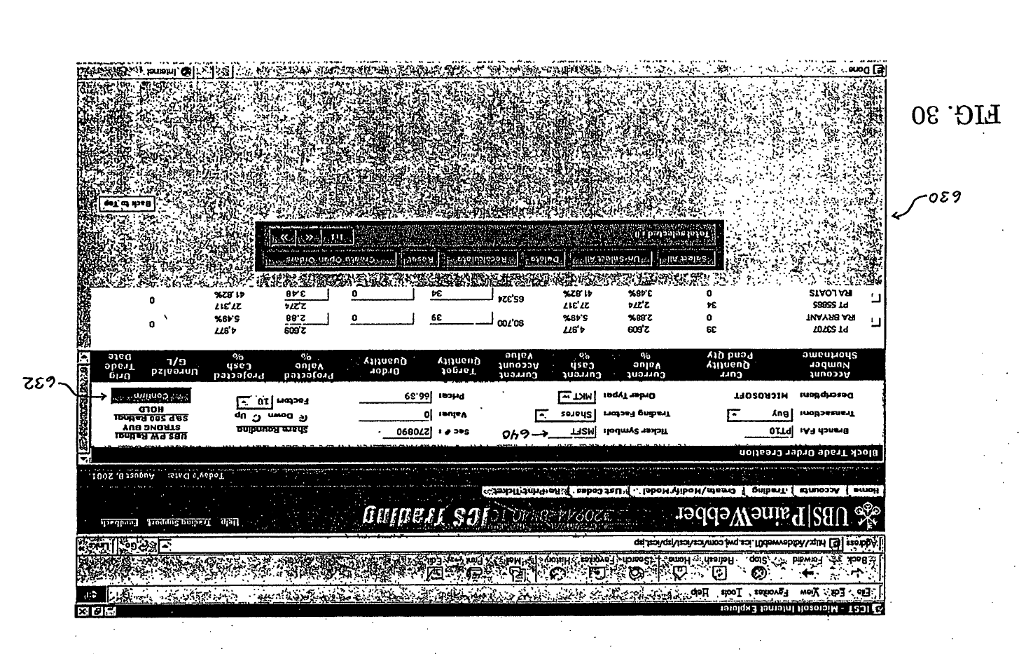

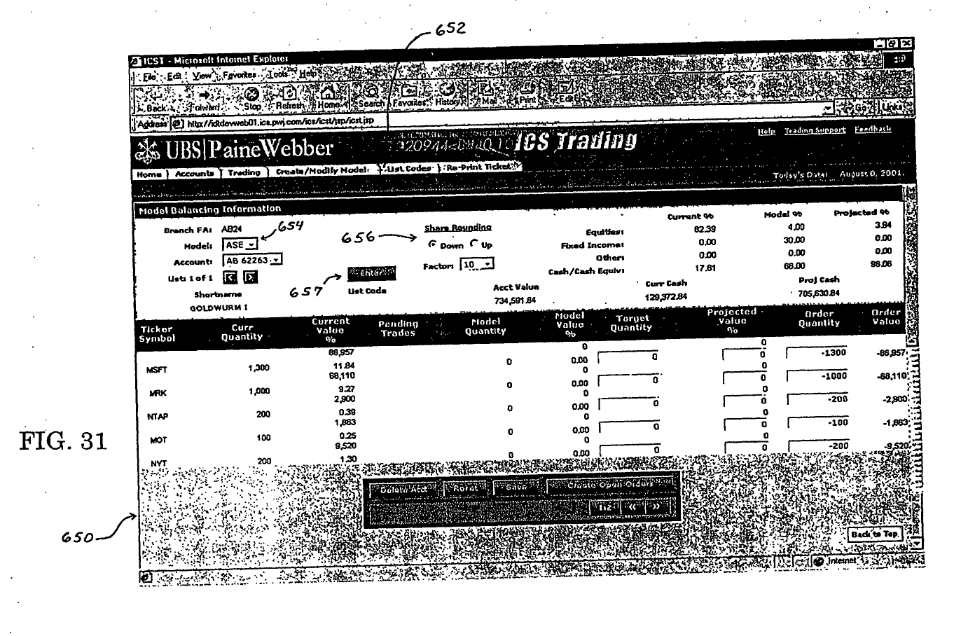

Once the user has a list of accounts, he or she can create trades for the list of accounts. The user must select the desired accounts to create trades by checking the check box 606. If one account is selected and the “trade now” button 608 is clicked, the system will navigate the user to a single order creation screen or tool 620, shown in FIG. 29. If more than one account is selected, and the “trade now” button 608 (FIG. 28) is clicked, the system will navigate the user to a block trade order creation screen or tool 630, shown in FIG. 30. The model balancing button 610 (FIG. 28) navigates the user to an account(s) vs. model balancing screen or tool 650, shown in FIG. 31, which allows the user to balance multiple accounts against a model and automatically create orders for those accounts so as to equalize the accounts with the model.

The single order creation screen or tool 620 (FIG. 29) allows the user to increase, decrease, and liquidate a position or add a new position for a single account. Clicking the “create open orders” button 622 causes the system to create an open order.

The block trade order creation screen or tool 630 (FIG. 30) allows the user to increase, decrease, liquidate, equalize a position or add a new position and create a block trade order for the list of accounts selected on the accounts list screen (FIG. 28). The user enters the following trade information (FIG. 30): transaction, ticker symbol, trading factor, value, order type and price, as well as a share-rounding factor. When the user clicks on the confirm button 632 the portfolio information for each security of each account is displayed.

To increase a position, the user enters the trade information and clicks on the confirm button 632 or he can increase the target quantity 634, order quantity 636 or projected value percent 638. Only one of these can be modified. Clicking on the recalculate button 639 initiates calculations to the other fields as a direct result of the modified field. Similarly, financial positions can be decreased, liquidated and equalized.

To add new a position, the user must type in the new ticker symbol in a ticker symbol box 640 as well as the other trade information and click on the confirm button 642. After the screen is populated with the new trade data, the user can increase the target quantity, order quantity or projected value percent. Only one of these fields can be changed. Once the change is made, clicking on the recalculate button 639 results in the other two editable values being re-calculated.

Clicking on the create open orders button 642 causes a block trading order to be created, i.e., one trade for a designated number of shares, portions of which are allocated to each account as specified in the block trade order creation screen 630.

The accounts vs. model balancing screen or tool 650 (FIG. 31) will allow the user to balance a single account, all accounts, or a subset of accounts against a specific financial model. A “list code” of accounts is a group of accounts selected through menu selection 652 on the basis of a predetermined code in account numbers such as the prefix “AB”. The user must select a model from a model drop-down list 654, enter a share-rounding factor 656 and click on an enter button 657. The screen or tool will then display actual positions and their portfolio percentages, model securities and their portfolio percentages, and new target quantity and percentages (based on the order values). By clicking on the create open orders button 658, the tool automatically creates buy and/or sell orders (subject to the share rounding factor) for financial product(s) required to balance the group of accounts against the selected model. Advantageously, the account balancing tool keeps track of all accounts and orders as well as the allocation resulting from the balancing operation. This is particularly useful for householded accounts, in which an individual or family may have a number of separate accounts but wish to have the aggregate portfolio (i.e., across all accounts) follow a pre-selected financial model.

The ICST also includes an open orders screen (not shown) that displays outstanding trade orders. Orders may be viewed by account or security. A button is provided to execute any open orders. Orders may be executed automatically or manually. Once the method of execution is decided upon, the user selects whether the order is market or limit, and if the latter, th elimit price. As soon as this information is entered, the user may press a “submit” button, thereby creating submitted orders or trades.

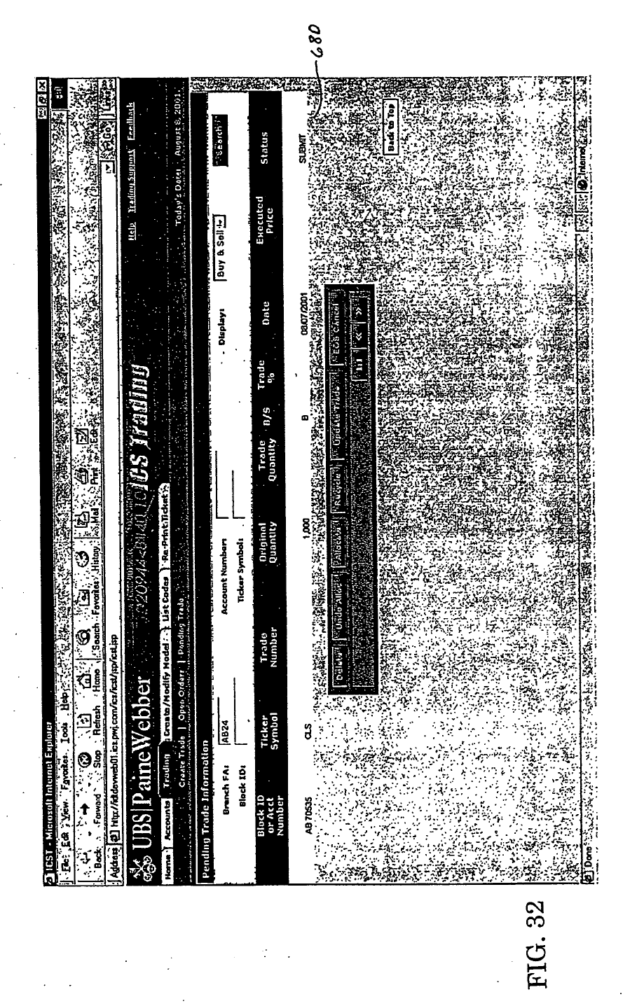

FIG. 32 shows a pending trade status screen that allows the user to view and modify all submitted trades. The user may:
allocate block trades that are either fully or partially executed
delete a manually submitted block trade or individual account
update block trade information
recycle a block trade
cancel an electronic order submission (EOS) trade that has unexecuted quantities
undo a manually submitted allocation

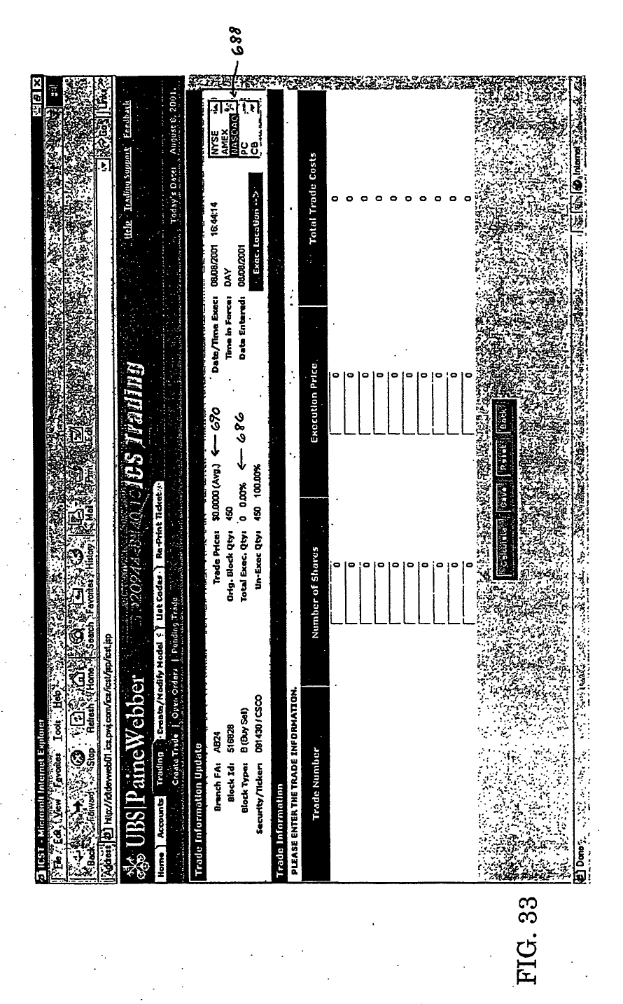

Clicking on an update trade button 684 will bring the user to a trade information update/trade information screen shown in FIG. 33. This screen is primarily used for manually submitted block orders, e.g., larger than 15,000 shares. From this screen the user can enter or update the number of shares executed 686, location 688 and price 690 for a block trade selected from the pending trade status screen. Clicking on a calculate button 692 and then a save button 694 saves the trade information for subsequent execution.

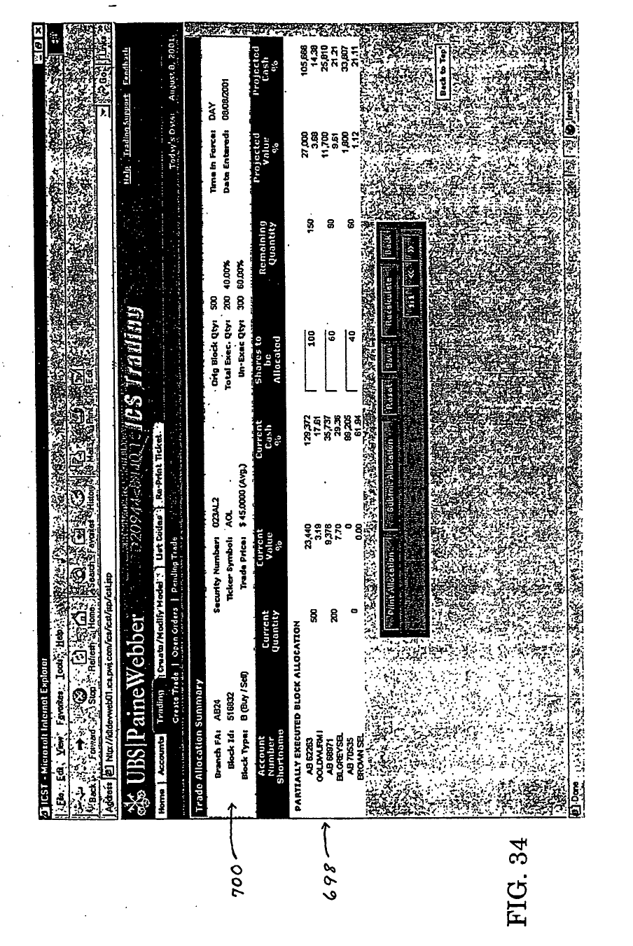

Clicking on an allocate button 696 (on the pending trade screen shown in FIG. 32) causes the system to navigate the user to a trade allocation summary screen, shown in FIG. 34. To allocate a fully executed block trade fully, its status 680 must be partially incomplete (PAR/INC) and the buy/sell percentage 682 must equal one hundred. To allocate a partially executed block trade, its status must be partially incomplete (PAR/INC) and the buy/sell percentage 682 must be less than 100. Manually entered block trade orders have an initial status of “submit” which will change to “partially incomplete” when the parameters of the block trade order are entered via the trade information update/trade information screen of FIG. 33. All orders submitted are blocked together at the time of submission.

The trade allocation summary screen (FIG. 34) allows the user to view, modify, print and submit allocations of block trades. The user must allocate block trades that are submitted manually, and can allocate block trades that are EOS partially executed. If the user makes any changes, he or she must save the changes prior to submitting the allocation by clicking a save button 702. If the user makes no changes, he or she still must click on the save button 702 prior to submitting the allocation for fully executed block trades. To submit the allocation, the user clicks on a submit allocation button 704.

The trade allocation summary screen will also allow the user to view, modify, print and assign individual allocations of manually submitted or partially executed block trades. After selecting the block from the pending trade status screen (FIG. 32) where the buy/sell percentage is less than one hundred and clicking on the update trade button 684, the system navigates the user to the trade information update/trade information screen (FIG. 33) to enter the number of share executed, price and location. When this is completed, the user is navigated back to the pending trade screen (FIG. 32). Clicking on the allocate button 696 will cause a partial allocation method form 698 (FIG. 34) to appear, where the user will be asked how to allocate the partially executed block. The user will have the option to allocate shares either pro-rata or randomly. If “pro-rata” is selected, the shares are allocated on a pro-rata basis. If “random” is selected, the shares are allocated on random basis. Once the user makes a choice on which allocation basis to use, clicking on an “OK” button returns the user to the trade allocation summary 700. To submit the allocation, the user must click on the save button 702 before clicking on the submit allocation button 704. If modifications are made to the shares to be allocated field 706, the recalculate button must also be clicked.

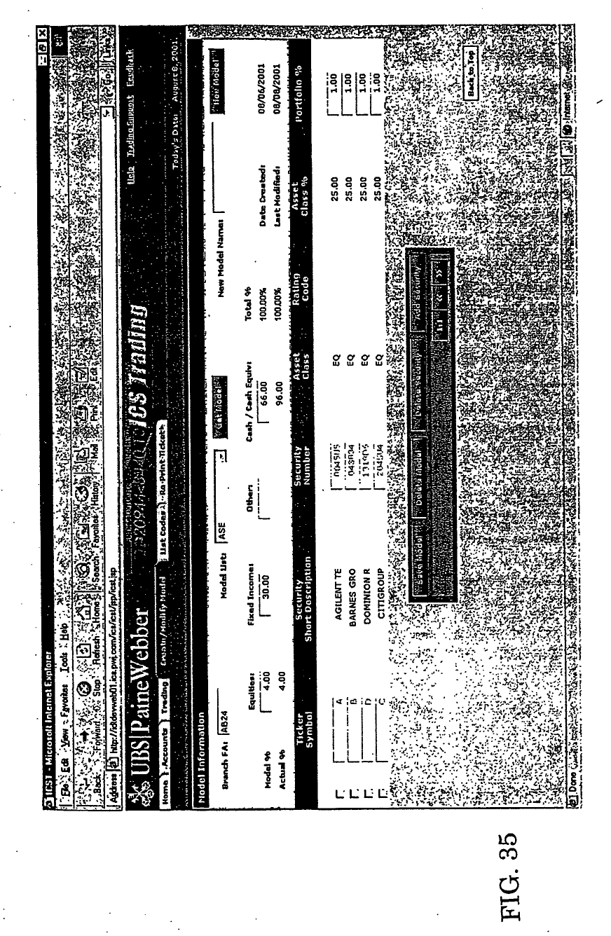

FIG. 35 shows a create/modify model screen or tool that allows the user to create a new model (simple or complex) and its criteria (asset class percentages or securities). It will also allow the user to modify an existing model and view a list of models.

A simple model is based on percentages of equities, fixed income, other and cash/cash equivalent. A complex model is based on percentages (equities, fixed income, other and cash/cash equivalent of the simple model plus desired securities.

The user will have the ability to add or delete securities from a model portfolio. There are two scenarios to add securities:

First, by clicking on the add security button 708, securities can be added by either entering a security number or ticker symbol and portfolio percentage. After adding all the desired securities, the user clicks on the save model button to save the securities information. Models can only be saved when the total portfolio percent of all the securities equals the equity model percentage (e.g., if Equity is set to 60%, then the percentages of all the equity type securities must equal 60%).

Second, a complex model can be modified three ways: it can be modified by deleting and adding securities, deleting securities without adding new ones, or adding securities without deleting existing ones. To delete a security, the user must check the check box of the desired security and click on the delete security button 710. Once a security is deleted, the user must change the portfolio percentages of the existing securities or add new securities before saving the model. The model equity percentage is automatically calculated base on the portfolio percentages of the securities in the model.

To balance accounts against a model the user just created or modified, he or she must either navigate to the account list screen and select an account, all accounts or a subset of accounts or navigate to the search filter screen to search, obtain an account, all accounts or a subset of all accounts from the accounts list screen and click on the model balancing button, (FIG. 28).

Client Info

As shown in FIG. 36, the client information task (command tab 402) provides links to the following objects: view 660, branch reports 662, and portfolio management reports 664. The view object 660 enables users to produce client account statements, trade confirmations, 1099 forms and 1042S forms, as indicated in FIG. 32.

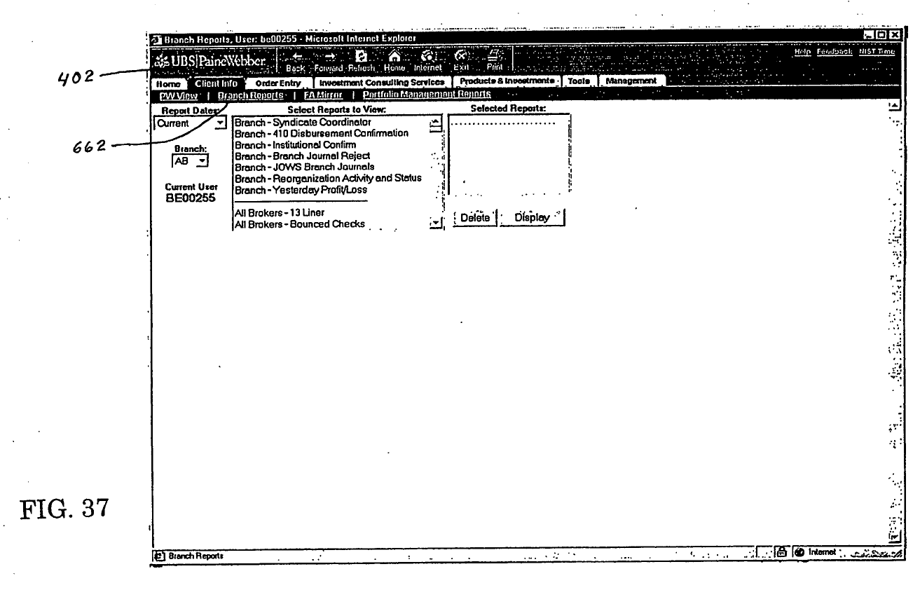

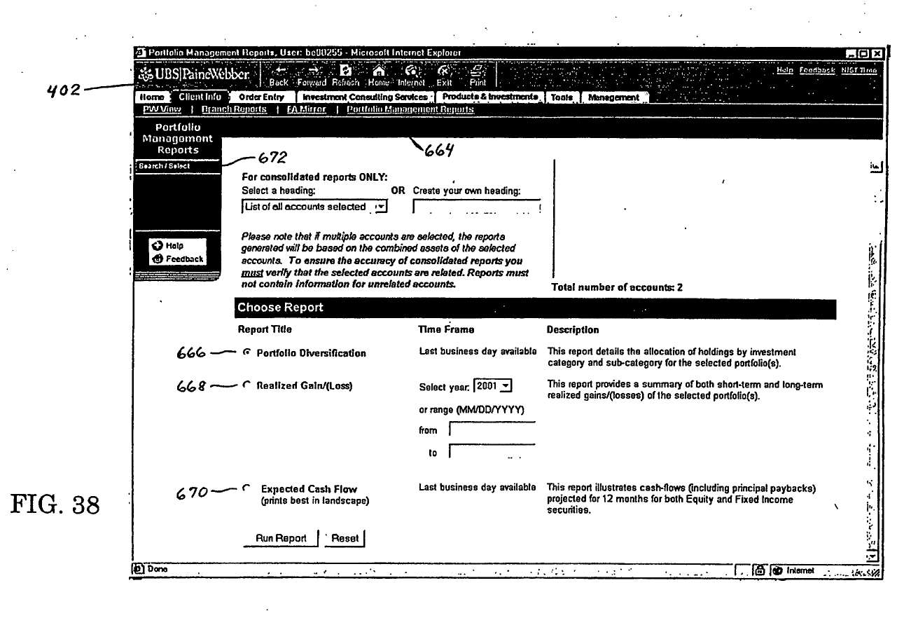

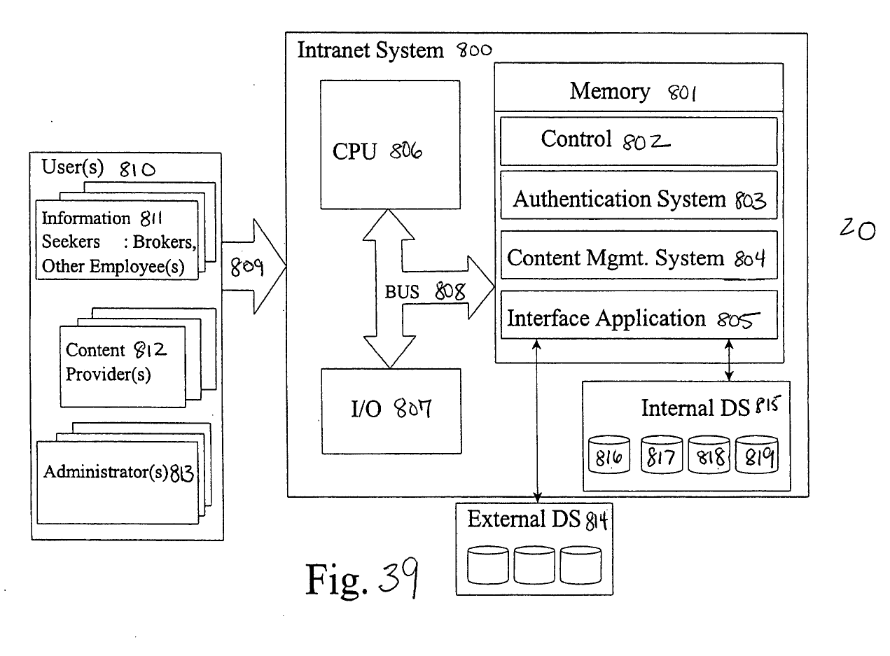

FIG. 37 shows the branch reports object 662, which provides various internal branch reports.

FIG. 38 shows the portfolio management reports object 664. The available reports include a portfolio diversification report 666, which details asset allocation by investment category for single or householded accounts. A realized gain/loss report 668 is also available, as is an expected cash flow report 670. All reports can be run either for one account or for combined multiple accounts.

The cash flow report details expected cash flows, including principle pay-backs, from portfolio holdings (including both equity and fixed income) for 12 monthly periods. This feature includes consolidated reporting, i.e., the ability to generate a cash flow from a plurality of combined accounts, which are selected from the account search menu selection 672. The report can be generated daily or for a user-selected time range.

Referring back to the portfolio diversification report 666, this report is separated by asset class, as for example,
cash (comprising commercial paper, money market funds and treasury bills);
equities (comprising ADR's, call options, convertible bonds, stock equities, master limited partnerships, and other equity investments, put options and warrants);
fixed income (comprising asset backed securities, certificates of deposit, collateralized mortgage obligations, corporate, federal, municipal and foreign notes and bonds, mortgage pass-through securities, and preferred securities;
other (comprising accident and health insurance payouts, annuities, disability insurance, life insurance, managed futures funds, precious metals, private investments; and
mutual funds (comprising closed and open-ended mutual funds).

A bar chart may also be presented, if desired.

Another embodiment of the present invention is described as follows:
I. System
II. Operation
   A. Overview
   B. Interface Application
   C. Content Management System
   D. Authentication System Detail
      I. System:

The present invention includes an intranet system for a financial to services entity, comprising an interface application for accessing at least one internal data source and at least one external data source that a user is entitled to access; and an authentication system for determining which data sources a user is entitled to access, displaying the data sources on the interface application and setting a user preference profile.

Referring to FIG. 39, a preferred embodiment of intranet system 800 is shown. Intranet system 800 is for a network of users 810 such as a financial services entity or corporation. In this setting, system 800 may provide users 810 with a wide variety of information for such activities as assisting client prospecting and consulting, presentation preparation, understanding compliance guidelines and regulations and determining available training. Accordingly, system 800 provides information on internal matters to the financial entity such as training, employee issues, corporate policy, products and services. Furthermore, system 800 provides information on external matters that are relevant to the entity's business, e.g., market data.

A “user” for purposes of this disclosure refers to any person or entity that may access intranet system 800, e.g., information seeker(s) 811 such as employees, broker(s), etc.; content provider(s) 812; administrator(s) 813; etc. It should be recognized that “content providers” may take a variety of forms such as brokers, division heads, human resource representatives, investment analyst, etc. Any person or entity within the preferred setting of a financial service entity that has information to be communicated to others within the financial service corporation may be a content provider.

Intranet system 800 includes a memory 801, a central processing unit (CPU) 806, input output (I/O) 807, and bus 808. Memory 801 may comprise any known type of data storage and/or transmission media, including magnetic media, optical media, random access memory (RAM), read-only memory (ROM), a data object, etc. Moreover, memory 801 may reside at a single physical location, comprising one or more types of data storage, or be distributed across a plurality of physical systems in various forms, e.g., host servers. CPU 806 may likewise comprise a single processing unit, or be distributed across one or more processing units in one or more locations, e.g., on a client and server. I/O 807 may comprise any known type of input output device, including a network system, modem, keyboard, mouse, voice, monitor, printer, disk drives, etc. Bus 808 provides a communication link between the components in system 800 and likewise may comprise any known type of transmission link, including electrical, optical, radio, etc. In addition, although not shown, additional components, such as cache memory, communication systems, etc., may be incorporated into system 800.

Stored in memory 801 are components of intranet system 800 including: control 802, authentication system 803, content management system 804 and interface application 805. An internal data source 815 may also be included for storing data. In a preferred setting, data source 815 is at least one database 816-819. Data source 815 may be local and may be one or more storage devices, such as a magnetic disk drive or an optical disk drive. In another preferred embodiment, data source 815 includes data distributed across a local area network (LAN), a wide area network (WAN) or a storage area network (SAN) (not shown). Data source 815 may also be configured in such a way that one with ordinary skill in the art may interpret it to include many databases 816-819. An external data source 814 is preferably provided on an external service provider server. External data source 814 may provide information not readily available to the financial service entity from internal sources, e.g., market data.

Intranet system 800 is linked to any number of users 810 via communication system 809 with, for example, a wide area networks (WAN), local area networks (LAN), other private networks or the Internet. Communication system 809 may also utilize conventional token ring connectivity, Ethernet, or other conventional communications standards. Where users 810 are connected to intranet system 800 via the Internet, connectivity is provided by conventional TCP/IP sockets-based protocol. In to this instance, users 810 could utilize an external Internet service provider to establish connectivity to intranet system 800. System 800 would provide functionality, as will be described below, through web sites accessible over the Internet by a user 810.

Each user 810 preferably has a user system or workstation (not shown) that includes a CPU; a video display screen (VDS); communication system for communicating between the workstation and system 800. A user's system may also include a core of interface application, as will be described below.

II. Operation:

A. Overview:

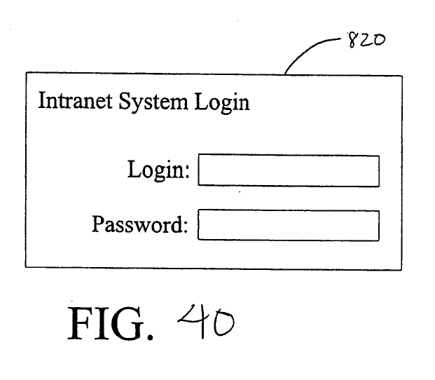

Operation of intranet system 800 will be described relative to FIGS. 40-46. Referring to FIG. 40, authentication system 803 provides a video display of a login 820 that is viewable at a system or workstation (not shown) of a user 810. The detailed operation of authentication system 803 is described in detail later. By filling in a login identification and password, a user 810 may access intranet system 800 through communication network 809. Activation of authentication system 803 may be provided by specialized software resident on a user 810 workstation that connects to intranet system 800. Alternatively, a user 810 may activate authentication system 803 by accessing an authentication system web site of intranet system 800 via a conventional web browser such as Microsoft Internet Explorer®.

Login information is transmitted to a security function (part of authentication system 803 of system 800) where a user 810 is authenticated. This provides for confirmation of a user's identity. Of course, a user will be denied access to the system where authentication does not occur. The security functionality described herein also represents a single point of security control for removing a user from the system. Preferably, the security function is resident in more than one host server of system 800 in order to provide load balancing and disaster recovery.

In addition, authentication system 803 also provides access to a user entitlement level that contains a list of applications that the user is allowed to access. That is, different users are entitled to access different information, applications and features resident in system 800. For example, a human resource representative would not be able to access investor-related information. In addition, authentication system 803 also accesses a user 810 customized preference profile resident on system 800. User preference profile allows a user to customize his or her interface application, e.g., settings, market data preferences, etc.

By providing these entitlement and preference profiles, the present invention allows a user to freely move between different locations and maintain access and preferences set at a user's own system or workstation, i.e., at their “home” office. Otherwise stated, these features provide nomadic capabilities that allow a single sign-on procedure which can be utilized with any user system; sometimes known as “free-seating”.

Upon authentication by authentication system 803, control 802 of system 800 activates either content management system 804 or interface application system 805 depending on the identity of the user 810 logging on.

B. Interface Application:

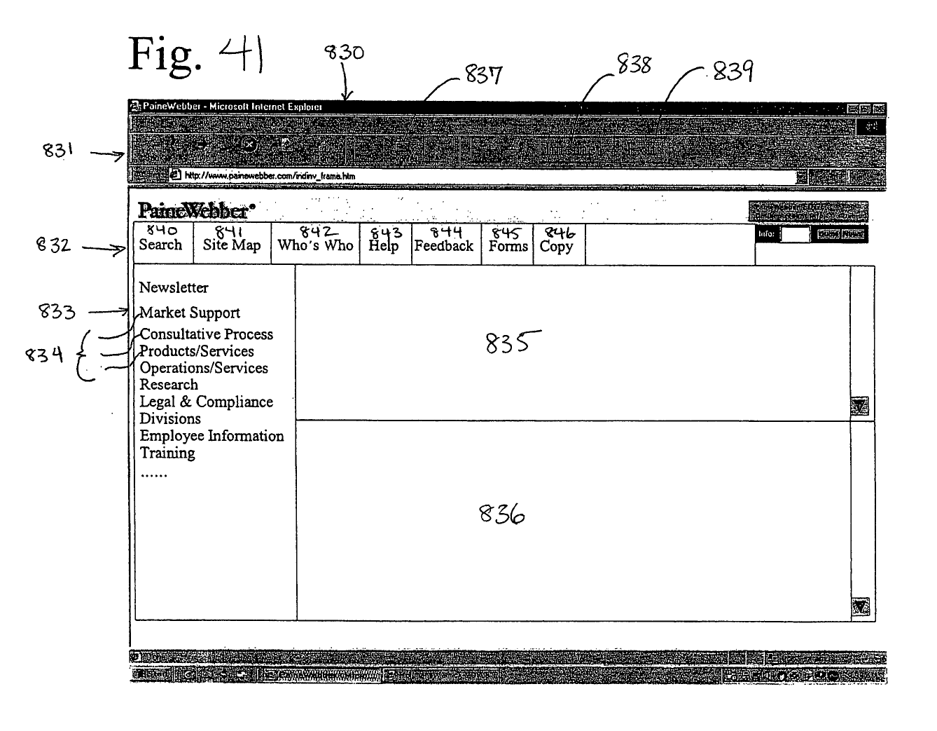

FIG. 41 illustrates an interface application 830. Interface application 830 is activated by control 802 when a successful logon has been completed for a user 810. In the case shown, user 810 is an information seeker 811 and, in particular, a broker. Interface application 830 provides a screen display of information that a user 810 is entitled to access as determined by authentication system 803. The ability of a user 810 to access system 800 using an interface application provides an advanced technology platform with a stable, fast operating environment, easy accessibility and usability, and the flexibility of remote computing.

As discussed above relative to system 800, where a user is connected to a host server via the Internet, connectivity is provided by conventional TCP/IP sockets-based protocol. In this network-based system, a user 810 workstation may be any computer, stationary or portable, that has Internet access such as an Internet service provider outside of the system 800 to establish connectivity to system 800. In this environment, all data is preferably encrypted, e.g., with 128-bit encryption techniques, to ensure account integrity will be maintained.

Interface application 830 includes a toolbar 831; a menu 833 for presenting available information selections 834 and providing navigation therebetween; global function selections 832; and at least one view window 835, 836 for presenting information from at least one data source 814, 815.

Toolbar 831 may include standard browser features such as: back, forward, stop, refresh/reload, home and print. Additionally, toolbar 831 preferably includes a favorites selection 837, an Internet selection 838 and an Exit selection 839. Internet selection 838 is only provided where the Internet is not the form of access by user 810. Internet selection 838 allows a user 810 to access the Internet in general for common search engine searching of the World Wide Web. For example, a user may conduct searches for investment information, background information, breaking news that affects investments and the like on such search engines as Yahoo®, Excite®, etc. General Internet access also allows a user 810 to communicate with other users and with clients via e-mail packages such as provided by Microsoft Outlook®. Exit selection 839 allows a user to successfully logoff of system 800.

Menu 833 provides a list of feature selections 834 that are available to user 810. Menu 833 will vary according to the entitlement level of a user 810. The feature selections 834 that a user can access through interface application 830 are determined by their entitlement level. As will be discussed later, authorization system 803 determines a user entitlement level and populates interface application 830 accordingly. The exemplary feature selections 834 shown are for a broker-type user and make available at least one of the following: newsletter, market support, consultative process, operations/services, research, legal & compliance, divisions, employee information and training. A different user, such as a human resource representative, may not have the same feature selections 834. It should be recognized that any number of additional feature selections 834 might be added according to a user's needs. Furthermore, fewer selections 834 may be presented.

Feature selections 834 are linked to data sources 814, 815 and can communicate for display various features, e.g., textual information, applications, special functions or web pages. Each feature selection 834 is preferably a hypertext link, the selection of which will force the selected feature to be activated/displayed in at least one view window 835 adjacent to menu 833. The data source 814, 815 that each feature selection 834 accesses will vary based upon the location of the data. For instance, employee information may be located on internal data source 815, while market support may be located on an external data source 814. The ability to access an external data source 814 allows system 800 to provide more options without entity-wide effort. One example of a preferred external data source is a real-time market data source such as Quotron®by Reuters®. This data source provides up-to-the-minute market data for users 810 such as brokers.

If necessary, once user 810 makes a selection, he or she can further navigate within view window(s) 835, 836 to access further levels of information, etc. In this way, a hierarchy of information, etc., may be created for organizational purposes.

As shown, more than one view window 835, 836 may be displayed at one time. This permits a user 810 to select more than one feature selection 834 and view the resultant information, applications, functions or web pages simultaneously on split screens 835, 836, or other layout as known in the art. Each view window 835, 836 may include conventional scroll bars as necessary. Based on the type of information desired, user 810 selects the appropriate feature selection 834. In accordance with the particular user selection, system 800 opens the selected entry and user 810 is able to view the feature selected. Broadly stated, once user 810 makes a selection, the data is either transmitted to the CPU of system 800 or is resident on the CPU of system 800. If transmitted, the CPU of a host server sends the data pertinent to the application selected to user 810 via network links or the Internet. This data is received by the user's CPU and uploaded into the RAM. The resultant graphical display on the user's VDS is controlled by the contents of the RAM in a conventional manner. Whenever a new entry is selected, the data is transmitted to the user in a similar manner. As previously mentioned, any number of information displays, applications, functions or web pages may be run concurrently. These displays can be viewed in any format (e.g., split screen, cascade, minimized) selected by user 810.

Global function selections 832 are selections that are available to user 810 regardless of the display or user entitlement level. Global function selections 832 preferably include search selection 840 for searching data sources 814, 815 for information, site map selection 841 to view data source's 814, 815 hierarchy, who's who selection 842 to access a corporate directory, help selection 843 for accessing help features, feedback selection 844 for accessing an e-mail feed back form and forms selection 845 for accessing internal forms. Global function selections 832 also preferably include a scratchpad application selector 846 for moving information between displays, applications, forms, etc. Although preferred global function selections 832 have been disclosed, it should be recognized that any number of additional features/selections might be added in a known fashion as desired by a user.

Advantageously, interface application 830 provides a seamless transition between the different features afforded by system 800 of the invention. The features available to a user are determined by a user's entitlement level, as will be described in more detail relative to authentication system 803. Interface application 830 thus acts as a “controlled shell” of features for a user in that only features that a user is entitled to access are provided to him or her.

It should be recognized that the particular appearance of application interface 830 may vary according to a user's preference profile, e.g., each user's toolbar, menu and global function selections may have different positions and/or different selections.

C. Content Management System:

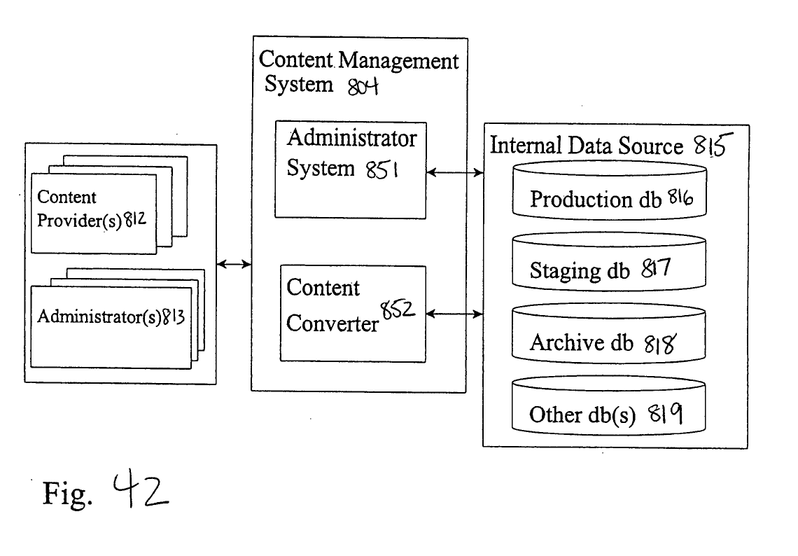

Referring to FIG. 42, content management system 804 of the present invention is illustrated in greater detail. Content management system 804 is activated by control 802 (shown in FIG. 39) when authentication system 803 determines that a user 810 logging on is a content provider 812 or an administrator 813. Content management system 804 includes administrator system 851 and content converter 852. For description purposes, as shown in FIG. 42, internal data source 815 preferably includes a production database 816 that stores active content available to users 810, staging database 817 for storing content in development and archive database 818 for storing old content. Other databases 819 may also be a part of internal data source 815 as required, e.g., for storing applications or special functions.

Administrator system 851 acts as an access mechanism, i.e., a front-end, to internal data source 815, and allows comprehensive control of internal data source 815 content. For instance, among the controls administration system 851 preferably provides include addition of new content, update of old content, updating of metadata, managing system-generated metadata regarding document status, managing content development and control processing, supporting archiving and deletion of content, managing the overall hierarchy of data source 815, managing attachments, administering appropriate hyperlinks and security, reviewing/previewing content in staging, etc.

Administrator system 851 controls movement of data between production database 816, staging database 817 and archive database 818. Administrative system 851 allows access to the different databases by the directories/files of the databases 816-819 that are accessible to an administrative user 812, 813 through an explorer application (not shown), e.g., Microsoft Windows Explorer®. Administrator system 851, in conjunction with authentication system 803, may also control assignment of user entitlement levels. Content management system 804 also preferably includes content converter 852, which takes content submissions from content provider(s) 812 that are usually submitted in some a non-hypertext markup language (i.e., non-HTML format such as Word, Excel, PowerPoint, etc.), and converts them to HTML. Content converter 852, hence, allows content provider(s) 812 to submit content for posting on intranet system 800 regardless of format.

It should be recognized that in certain circumstances, a content provider 812 may be entitled to access content management system 804 and/or internal data source 815 directly. For instance, where information is time-sensitive, a content provider 812 may be given an entitlement level by authentication system 803 that allows for direct access to production database 816 and, hence, immediate posting of content.

D. Authentication System Detail:

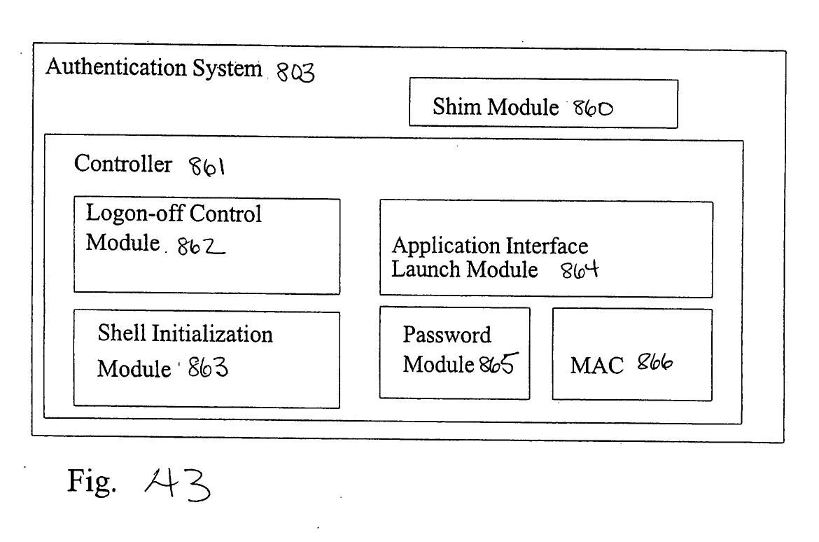

Referring to FIGS. 43-46, authentication system 803 of the invention is shown in greater detail. Authentication system 803 allows a user 810 to access features of system 800 that he or she is entitled to. For instance, brokers may be entitled to access only the features shown on interface application 830 in FIG. 41. A human resource representative may be allowed access to the same features excepting market support and legal & compliance information as such information is not relevant to their position.

Similarly, authentication system 803 may determine access of a user 810 at a content provider(s) 812 level or an administrator(s) 813 level and provide appropriate access to content management system 804. A content provider level may allow submission of content to a staging database 817 of internal data source 815, but no other access. Another content provider level may provide access to staging database 817 and production database 816 for time-sensitive content posting. An administrator level will allow complete access to administrator system 851 to control content of internal data source 815, i.e., control data/content movement between production database 816, staging database 817, archive database 818 and/or other database(s) 819. As noted above, administrator system 851 may allow access to the different databases by the directories/files of the databases 816-819 that are accessible to an administrative user 812, 813 through an explorer application (not shown), e.g., Microsoft Windows Explorer®.

For non-administrative users, features user 810 is entitled to access are provided at interface application 830 and are pre-determined by a user's entitlement level, e.g., the system provides a control list of features that a user may use. Authentication system 803 uses the entitlement level to build interface application 830 for a user. A user entitlement level is stored in an entitlement database(s) within system 800 and may include a number of identifications or passwords for user 810, e.g., home wirecode, home branch group, external data source 814 server ID, and security ID. A particular user 810 system or workstation may also be limited in access and also include an entitlement level stored in an entitlement database(s) within system 800.

A customized user preference profile is also stored in a database(s) 819 within system 800 and contains customized settings of a user 810, e.g., user's toolbar 831 settings, etc. A user's preference profile is used to build interface application 830 and provide the user with preferences that he or she previously set.

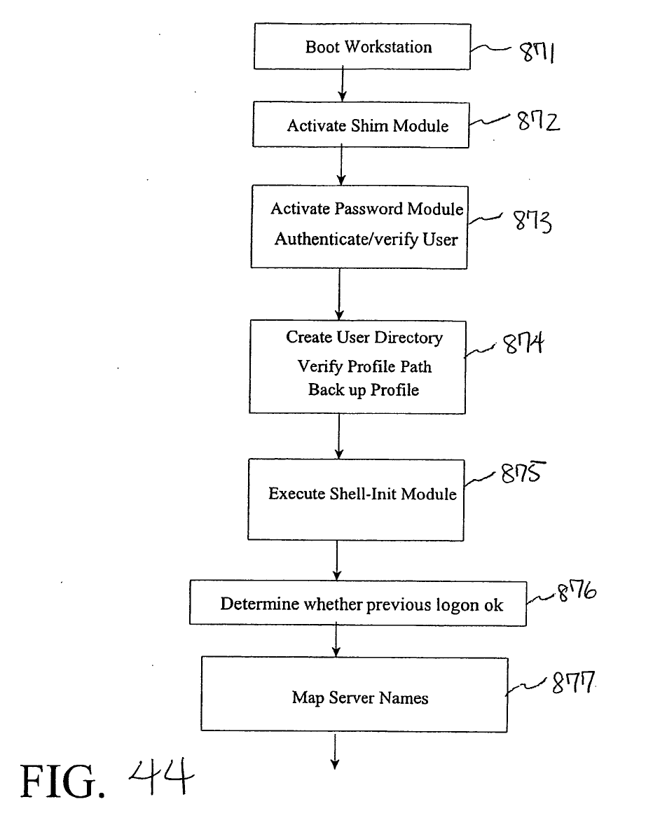

As shown in FIG. 43, authentication system 803 includes a shim module 860, a controller 861, a logon-off control module 862, a shell initialization module 863, an interface launch module 864, a password module 865 and MAC 866. Operation of authentication system 803 will be described relative to FIGS. 44-46. It is also noted that authentication system 803 will be described relative to a system 800 having a multiple component host server. While authentication system 803 is preferably used in a distributed server system, it should be recognized that the servers described might be condensed into a single server.

Referring to FIG. 44, in a first step 871, a user boots a user system or workstation (not shown), i.e., turns on or re-starts a workstation.

In step 872, a normal boot sequence is interrupted and shim module 860 is activated to direct operation to logon-off control system 862, i.e., standard workstation protocols (e.g., Winlogon) are interrupted. Logon-off control system passes through all requests for service to controller 861 and loads shell initialization module 863 and interface system launch module 864. In a preferred embodiment, shim module 860 replaces a Microsoft® graphical identification and authentication dynamic link library (GINA dll) that operates with the Winlogon component of Microsoft® Windows NT® with a special system GINA dll that acts as controller 861.

As will become evident, controller 861 (sometimes through modules 860, 862, 863, 864, 865) governs a number of activities including retrieving a user's preference profile; populating interface application 830; finding a user's entitlement level; retrieving numerous user identifications (e.g., home wirecode, home branch group, external data source 814 server ID, and security ID for use by shell initialization module 863); creating a local user directory based on a user's preference profile; storing user password(s) in a library for applications to retrieve; setting an access control list on a logging-in user's directory to provide full control; verifying and backing up user preference profiles; removing local preference profiles (excepting defaults, administrative and guest settings); and notifying a user of password expiration.

As one with ordinary skill in the art will recognize, when a user 810 accesses system 800 over the Internet, steps 871 and 872 do not take place because the user system or workstation has already been booted. In this setting, when user 810 accesses a login web page of system 800, shim module 860 replaces a Microsoft® graphical identification and authentication dynamic link library (GINA dll) that operates with the Winlogon component of Microsoft® Windows NT® with a special system GINA dll that acts as controller 861. Logon-off control module 861 then passes through all requests for service to controller 861 and loads shell initialization module 863 and interface system launch module 864.

At step 873, controller 861 authenticates a user logging-on by activating password module 865. Password module 865 may access a special security server (not shown) to authenticate a user. Upon initialization of security server, a user will be presented with a dialog for input of a user name and password.

Controller 861 may also indicate that a password change is required, i.e., it is about to expire based on information from the security server. At this time, a move/add/change (MAC) function 866 notifies the user that a password-reset operation has been performed and the password must be changed. The password may be changed in any conventional way of inputting a new password with a confirmation. MAC function 866 also updates a security function with new or revised user names, social security functions, advisor identification number (where appropriate), identification for market data entitlements, and satellite branch identifiers (where appropriate), as well as an email alias and title.

At step 874, controller 861 creates a local user directory, verifies a user preference profile path for the user exists and backs up the user preference profile. A user preference profile may exist on a local user workstation server or another server within system 800, i.e., they may be local or remote. A user preference profile includes a number of directories and files of the user, called a registry, that are used by system 800 to access a user's information. If controller 861 cannot verify a path, authentication system 803 uses a default profile. If a registry fails to load for a user, controller 861 may attempt to use a user's last known profile, which may be accessible from a back up of the profile. Creating a local user directory on a user's system or workstation includes mapping the directories of the system or workstation the user is using to the registry of directories and files for a user.

At step 875, after a user is authenticated, logon-off control 862 executes shell-initialization module 863 (hereinafter “shell-init module”).

At step 876, shell-init module 863 determines whether a previous logon did not proceed normally. If so, shell-init module 863 undoes the changes made during the last logon, i.e., it remembers user preference profile changes made during the previous logon.

At step 877, shell-init module 863 maps server names for user information to server IP address and port number. This is accomplished by determining a physical wire code from where a user's current workstation's local server is physically located; a user's home server wire code from the user preference profile; and a user's parent server wire code by querying workstation's local server entitlement data. A user “home” server is one that is located at a user's own main office; a “parent” server is one to which a group of user home servers are connected, i.e., a division server.

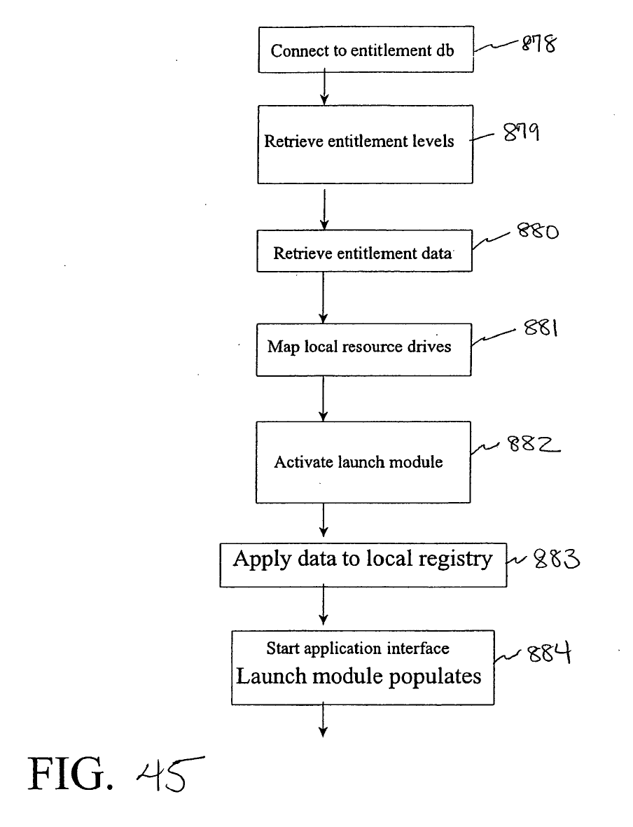

Next, turning to FIG. 45, at step 878, shell-init module 863 connects to an entitlement database, located on a server within system 800. Access to user entitlement level is based on the user identity input at authentication. Shell-init module 863 attempts first to access a user's home server entitlement database to determine this information. If unable to do so, system 800 has a failover to a central server entitlement database. A “central” server is one to which a number of parent servers are connected and may include duplicate entitlement databases.

Next at step 879, shell-init module 863 retrieves a particular user's system or workstation entitlement level and the user's entitlement level. In particular, shell-init module 863 retrieves a list of user identifications for accessing particular data source 814, 815 features. These identifications are stored for use by interface application 830.

At step 880, shell-init module 863 logs-on to an appropriate server and retrieves entitlement data. Shell-init module 863 secures registry entries for interface application 830, attains a user control list of features, a batch file for interface system launch module 864, and a user's parent wire code.

Next at step 881, shell-init module 863 may map a user's system or workstation's local resource drives to a user's directories/files, i.e., distributed file system (DFS), by reading from the user's preferences and substituting variables with wire codes, branch groups and usernames as appropriate. DFS may be located in any of system 800's host server's component servers.

At step 882, shell-init module 863 activates interface system launch module 864, which runs throughout a user's session. Interface system launch module 864 builds menu 833, starts toolbar 831, and handles security ticket expiration, user log-off and user system or workstation restorations. With to special regard to security ticket expiration, launch module 864 continually monitors a security time ticket and gives a warning to a user when time is about to expire. This is provided by querying password module 865 to determine what time allotment a user may have.

Next at step 883, launch module 864 applies the entitlement data to the local workstation registry, i.e., it removes the local preference profile of the workstation the user is using. Thereafter, launch module 864 signals controller 861 to start interface application 830.

At step 884, controller 861 starts interface application 830, and launch module 864 populates menu 833 with the user's entitled data source 814, 815 features, and starts toolbar 831 and any other ancillary processes. During this time, launch module 864 retrieves pathnames of executables to launch from the registry. For instance, external data source(s) 814 may require a user identification and password in order to access data stored thereat. Some features execute and are monitored, some execute but are not monitored, and some execute at log-off. These are monitored by launch module 864 so appropriate action may be taken.

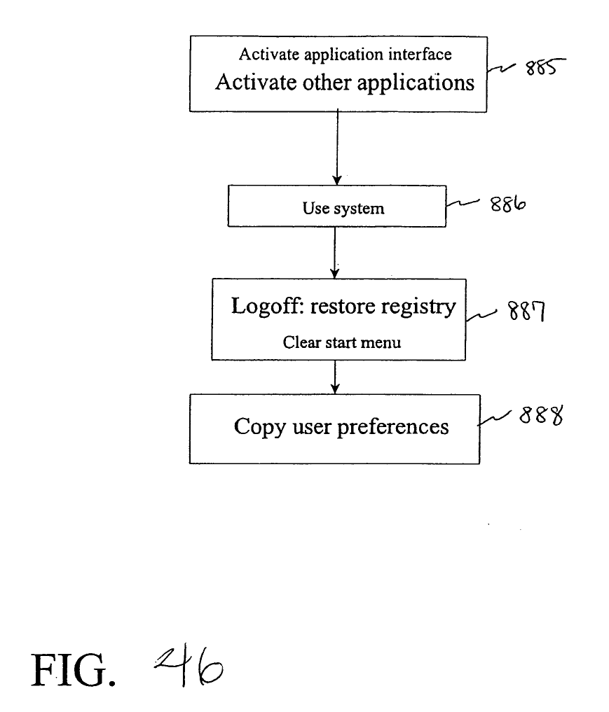

At step 885, shown in FIG. 46, launch module 864 activates interface application 830.

At step 886, the system is used to investigate information, learn about regulations and compliance, conduct various finance-related activities such as advising investors, or the like. In this way, the user can provide the investor with timely, proactive financial advice and gain a variety of information about the finance service entity. Similarly, a user 810 can obtain information about a variety of aspects of financial service entity, e.g., internal policies, holidays, employee matters, etc. Launch module 864 monitors a user's time versus a security ticket expiration and notifies a user when his/her time is about to expire. The notification may provide a user with the ability to extend the ticket, otherwise, the user will be forcibly logged-off.

At step 887, a user logs-off the system 800, at which time launch module 864 restores the user workstation registry entries that were in place to prior to the user's sessions and clears the start menu. A log-off may be instigated by selecting Exit selection 839 of interface application 830.

At step 888, launch module 864 passes control back to standard workstation protocols, e.g., Winlogon, and controller 861 copies a user's preferences from local cache to the location from which it attained them as appropriate so a user's changes can be accessed the next time the user logs on.

The authentication system 803 thus described allows a user to access features, i.e., information, applications, functions and web pages, according to entitlement levels and provides a user preference profile for that user regardless of where a user is physically located. As such, the system 803 allows a user 810 to logon anywhere and have all of the features and preferences available as if they were at their own workstation.

Having thus described the invention in rather full detail, it will be recognized that such detail need not be strictly adhered to but that various changes and modifications may suggest themselves to one skilled in the art, all falling within the scope of the invention, as defined by the subjoined claims.

What is claimed is:

1. An intranet system for a financial services entity, comprising:
an interface application for accessing a plurality of features that correspond to financial service applications that provide information for client prospecting and consulting, at least one internal data source, and at least one external data source that a user is entitled to access, wherein that internal data source provides information on internal matters to the financial service entity comprising information regarding financial products and services provided by the financial service entity and the external data source comprises a real-time market data source that provides real-time financial market data, and wherein the data sources provide information for the plurality of financial service applications that provide information for client prospecting and consulting; and
an authentication system for
determining which features of the plurality of features that correspond to financial service applications for client prospecting and consulting, and the respective data sources a user is entitled to access, wherein the features comprise a real-time market application for accessing real-time market quotes provided by the external data source, and an application for accessing information regarding financial products and services provided by the financial service entity provided by the internal data source,
displaying a list of the features corresponding to the plurality of financial service applications that provide information for client prospecting and consulting available to the user based on entitlement,
displaying, in response to a user selecting an available feature, the information provided by the financial service application corresponding to the selected feature, wherein the information provided comprises the information regarding financial products and services provided by the financial service entity, and the real-time market quote data supplied by the data sources,
setting a user specified preference profile, the authentication system allowing a user to access features according to entitlement, and
accessing the user preference profile to provide a user customized interface independent of the user's location.

2. A system as recited by claim 1, wherein the features further comprise a financial service application selected from the group consisting of, marketing support, consultative services, operations, research, legal, divisions, employment and training applications.

3. A system as recited by claim 1, wherein the interface application includes global function selections.

4. A system as recited claim 1, wherein the interface application further includes a scratchpad application for moving information between displays.

5. A system as recited by claim 1, wherein the authentication system populates the interface application based on user entitlements.

6. A system as recited by claim 5, wherein the authentication system provides access to the system using a single log-on process.

7. A system as recited by claim 1, further comprising a data source content management application.

8. A system as recited by claim 7, wherein the authentication system determines a user entitlement level to access the content management application.

9. A system as recited by claim 7, wherein the authentication system allows access to a content provider level and an administrator level.

10. A system as recited by claim 7, wherein the content management application includes a content converter.

11. A system as recited by claim 7, wherein the content management application includes an administrator system for managing content of an internal data source.

12. A system as recited by claim 11, wherein the administrator system controls movement of data between a production database, a staging database and an archive database.

13. The system as recited by claim 1, wherein the interface application further comprises a browser interface, wherein the browser interface comprises
a browser toolbar;
a task menu providing a plurality user-selected tasks, each task being associated with financial service applications;
an object menu associated with a user-selected task, the object menu providing the user with a user-selectable link for initiating each financial service application associated with the user-selected task;
an action menu for presenting one or more actions specific to a user-selected financial service application; and
at least one view window for presenting information from at least one of the financial service applications.

14. The system as recited by claim 13, wherein each task selection is associated with an object menu that is viewable when the task is selected by the user.

15. The system as recited by claim 13, wherein the task menu presents one or more of the following task selections:
a default task;
a client information;
an investor consulting service;
products and investments;
tools; and
management.

16. The system as recited by claim 13, wherein the default task is associated with one more of the following object menu selections:
research;
applications;
market data;
client inquiring;
infonet; and
dynamic market data.

17. The system as recited by claim 15, wherein the investor consulting services task is associated with one more of the following object menu selections:
online portfolio review;
financial planning; and
trading.

18. A system for providing financial information to end users in a network environment, comprising:
an interface having
means for selectively displaying a plurality of features that correspond to financial service applications that provide information for client prospecting and consulting, information from an internal data source that provides information on internal matters to a financial service entity comprising information regarding financial products and services provided by the financial service entity and an external data source that comprises a real-time market data source that provides real-time financial market data, and wherein the data sources provide information for the plurality of financial service applications that provide information for client prospecting and consulting; and
means for controlling the display of information; and
an authentication system having
means for determining a set of features of a plurality of features that correspond to financial service applications for client prospecting and consulting and data sources the a user is entitled to selectively access and display a list of available features based on user entitlement, wherein the features comprise a real-time market application for accessing real-time market quotes provided by the external data source, an application for accessing information regarding financial products and services provided by the financial service entity provided by the internal data source, and information regarding at least one of training, employee issues, and corporate policy;
means for displaying data supplied by the data sources in response to a user selecting an available feature; and
means for setting user specified preferences for the user based on a stored user preference profile, the authentication system allowing a user to access features according to entitlement and accessing the user preference profile accessed to provide a user customized interface independent of the user's location.

19. A system as claimed by claim 18, further comprising means for managing content of an internal data source.
